(19) United States
(12) Patent Application Publication
(10) Pub. No.: US 2017/0105134 A1
(43) Pub. Date: Apr. 13, 2017

(54) APPARATUS AND METHOD FOR MEASURING RECEPTION SIGNAL IN COMMUNICATION DEVICE

(71) Applicant: Samsung Electronics Co., Ltd., Gyeonggi-do (KR)

(72) Inventors: Haechul LEE, Gyeonggi-do (KR); Mingoo KIM, Gyeonggi-do (KR); lnhyoung KIM, Gyeonggi-do (KR); Joohyun DO, Seoul (KR)

(73) Assignee: Samsung Electronics Co., Ltd.

(21) Appl. No.: 15/277,497

(22) Filed: Sep. 27, 2016

(30) Foreign Application Priority Data
Oct. 12, 2015 (KR) 10-2015-0142305

(51) Int. Cl. H04W 24/08

(52) U.S. Cl. CPC H04W 24/08; H04W 72/085

(57) ABSTRACT

An apparatus and method for measuring a quality of a received signal of a user equipment (UE) are provided. The UE includes a bandwidth setting unit configured to determine a measurement bandwidth for a neighboring BS based on at least one bandwidth determined by a serving BS of the UE, and a measurement unit configured to measure a quality of a received signal based on the measurement bandwidth for the neighboring BS.

### PRIORITY

This application claims priority under 35 U.S.C. §119(a) to Korean Patent Application Serial No. 10-2015-0142305, which was filed in the Korean Intellectual Property Office on Oct. 12, 2015, the entire disclosure of which is incorporated herein by reference.

### BACKGROUND

1. Field of the Disclosure

The present disclosure generally relates to an apparatus and method, and more particularly, to an apparatus and method for measuring a received signal in a communication device.

2. Description of the Related Art

In a cellular wireless network, a user equipment (UE) in connected mode or in idle mode may measure received signals of a serving evolved node B (eNB) and neighboring eNBs and report the measurement result to the eNB. The measurement result may be used for various purposes in the cellular wireless network. For example, when the UE is in idle mode, the measurement result may be used for cell reselection. When the UE is in connected mode, the measurement result may be used for handover. In addition, the measurement result may be used to control transmit power of the UE or the eNB, or to perform downlink scheduling or uplink scheduling.

For the measurement, the eNB provides the UE with a dedicated control message including bandwidth information (hereinafter, referred to as a measurement bandwidth of the UE) for measuring the received signal. The UE measures the received signal based on the measurement bandwidth.

For example, a long term evolution (LTE) system provides the UE with the measurement bandwidth information as an ‘allowedMeasBandwidth’ value of MeasObjectEvolved universal terrestrial radio access (EUTRA) of a radio resource control (RRC) connection reconfiguration message. The parameter allowedMeasBandwidth indicates a maximum allowed measurement bandwidth (mbw) in a carrier frequency and includes one of mbw6, mbw15, mbw25, mbw50, mbw75, and mbw100. The values mbw6, mbw15, mbw25, mbw50, mbw75, and mbw100 indicate 6, 15, 25, 50, 75, and 100 resource blocks (RBs) respectively. 6RB, 15RB, 25RB, 50RB, 75RB, and 100RB may correspond to measurement bandwidths 1.4 MHz, 3 MHz, 5 MHz, 10 MHz, 15 MHz, and 20 MHz respectively. Typically, the measurement bandwidth may be smaller than, or equal to, a channel bandwidth of the eNB. The channel bandwidth indicates a bandwidth of an eNB radio frequency (RF) signal.

The LTE system performs intra-frequency measurement, inter-frequency measurement, and inter-radio access technology (RAT) measurement. The LTE system adopts carrier aggregation which aggregates two or more component carriers (CCs) to support a wider transmit bandwidth.

A conventional UE in the cellular wireless network measures a received signal based on a measurement bandwidth (e.g., the parameter allowedMeasBandwidth) determined by the eNB regardless of the received signal measurement type (e.g., the intra-frequency measurement, the inter-frequency measurement, and the inter-RAT measurement).

### SUMMARY

Accordingly an aspect of the present disclosure provides an apparatus and method for received signal measurement with higher accuracy and reliability than received signal measurement based on a measurement bandwidth determined by an eNB.

Another aspect of the present disclosure provides an apparatus and method for measuring a received signal to enhance accuracy and reliability in a communication device.

Another aspect of the present disclosure provides an apparatus and method for adaptively determining a measurement bandwidth in a communication device.

Another aspect of the present disclosure provides an apparatus and method for determining a received signal measurement bandwidth based on a measurement type in a communication device.

Another aspect of the present disclosure provides an apparatus and method for determining a received signal measurement bandwidth by comparing an eNB channel bandwidth with the measurement bandwidth in a communication device.

Another aspect of the present disclosure provides an apparatus and method for estimating a channel bandwidth of an eNB in a communication device.

Another aspect of the present disclosure provides an electronic device including a communication device is provided which adaptively determines a measurement bandwidth, and an operating method thereof.

Another aspect of the present disclosure provides an apparatus of a user equipment (UE) for measuring a quality of a received signal. The apparatus includes a bandwidth setting unit configured to determine a measurement bandwidth for a neighboring BS based on at least one bandwidth determined by a serving BS of the UE, and a measurement unit configured to measure a quality of the received signal based on the measurement bandwidth for the neighboring BS.

Another aspect of the present disclosure provides a method for operating a user equipment (UE) for measuring a quality of a received signal. The method comprises determining a measurement bandwidth for a neighboring base station (BS) based on at least one bandwidth determined by a serving BS of the UE, and measuring a quality of the received signal based on the measurement bandwidth for the neighboring BS.

Another aspect of the present disclosure provides a communication device for determining a quality of a signal. The communication device comprises at least one transceiver and at least one processor. The at least one transceiver is configured to receive the signal. The at least one processor is configured to determine a measurement bandwidth for a base station (BS) based on at least one of a gap bandwidth, a channel bandwidth for a serving BS of the communication device, and a predetermined bandwidth in a storage of the communication device. Also, the at least one processor is further configured to determine the quality of the signal based on the measurement bandwidth for the BS.

### BRIEF DESCRIPTION OF THE DRAWINGS

The above and other aspects, features, and advantages of the present disclosure will be more apparent from the following detailed description taken in conjunction with the accompanying drawings, in which:

FIG. 1A illustrates a cellular communication network, according to an embodiment of the present disclosure;

FIG. 1B illustrates synchronization between an evolved node B (eNB) and a user equipment (UE), according to an embodiment of the present disclosure;

FIG. 1C illustrates radio resource control (RRC) connection reconfiguration between an eNB and a UE, according to an embodiment of the present disclosure;

FIGS. 2A and 2B illustrate a relationship between an eNB channel bandwidth and a measurement bandwidth, according to an embodiment of the present disclosure;

FIG. 3 is a graph illustrating estimated reference symbol received power (RSRP) based on a measurement bandwidth, according to an embodiment of the present disclosure;

FIG. 4 is a block diagram of an electronic device, according to an embodiment of the present disclosure;

FIG. 5 is a block diagram of a communication device, according to an embodiment of the present disclosure;

FIG. 6 illustrates a bandwidth setting unit, according to an embodiment of the present disclosure;

FIG. 7A illustrates a transmission interval and a gap in a UE connected mode, according to an embodiment of the present disclosure;

FIG. 7B illustrates discontinuous reception (DRX) in a UE idle mode, according to an embodiment of the present disclosure;

FIGS. 8A and 8B illustrate inter-frequency measurement when two component carriers (CCs) are supported, according to an embodiment of the present disclosure;

FIG. 9 is a flow chart of a method for measuring a received signal in a UE, according to an embodiment of the present disclosure;

FIGS. 10A through 10D illustrate intra-frequency measurement, according to an embodiment of the present disclosure;

FIG. 11 is a flow chart of a method for intra-frequency measurement in a UE, according to an embodiment of the present disclosure;

FIGS. 12A and 12B are flowcharts of a method for determining a measurement bandwidth based on a channel bandwidth of a neighboring eNB, according to an embodiment of the present disclosure;

FIG. 13 is a flow chart of a method for intra-frequency measurement in a UE, according to an embodiment of the present disclosure;

FIG. 14 is a flow chart of a method for determining a bandwidth in a UE, according to an embodiment of the present disclosure;

FIG. 15 is a flow chart of a method for determining a bandwidth in a UE, according to another embodiment of the present disclosure;

FIGS. 16A and 16B illustrate inter-frequency measurement and inter-radio access technology (RAT) measurement, according to an embodiment of the present disclosure;

FIG. 17 is a flow chart of a method of inter-frequency measurement and inter-RAT measurement in a UE, according to an embodiment of the present disclosure;

FIG. 18 is a flow chart of a method for determining a bandwidth in a UE according to another embodiment of the present disclosure;

FIG. 19 is a flow chart of another method for determining a bandwidth in a UE, according to another embodiment of the present disclosure;

FIG. 20 is a flow chart of another method for determining a bandwidth in a UE, according to another embodiment of the present disclosure;

FIG. 21 is a flow chart of a method for measuring a received signal in a UE, according to another embodiment of the present disclosure;

FIG. 22 is a flow chart of a method for determining a bandwidth in a UE, according to another embodiment of the present disclosure;

FIG. 23 is a flow chart of a method for estimating a channel bandwidth of an eNB in a UE, according to an embodiment of the present disclosure; and

FIG. 24 is a graph of eNB channel bandwidth measurements in a UE, according to an embodiment of the present disclosure.

### DETAILED DESCRIPTION

The following description, with reference to the accompanying drawings, is provided to assist in a comprehensive understanding of various embodiments of the present disclosure as defined by the claims and their equivalents. The description includes various specific details to assist in the understanding, but they are to be regarded as merely examples. Accordingly, those of ordinary skill in the art will recognize that various changes and modifications of the various embodiments described herein may be made without departing from the scope and spirit of the present disclosure. In addition, descriptions of well-known functions and constructions may be omitted for clarity and conciseness. Throughout the drawings, similar reference numerals may be used to designate similar elements, parts, components and structures.

The expressions “have”, “may have”, “include” or “may include” and the like, used in the present disclosure are intended to indicate the presence of a corresponding characteristic (e.g., a number, a function, an operation, or a constituent element such as a component), and should be understood that there are additional possibilities of one or more additional characteristics.

In the present disclosure, the expressions “A or B”, “A and/or B”, or “one or more of A and/or B” and the like may include all possible combinations of items. For example, “A or B”, “at least one of A and B”, or “at least one of A or B” may indicate all cases where (1) at least one A is included, (2) at least one B is included, and (3) at least one A and at least one B are both included.

Although expressions used in various embodiments of the present disclosure such as “1st”, “2nd”, “first”, “second” and the like, may be used to express various elements, they are not intended to limit an order and/or importance thereof. The above expressions may be used to distinguish one element from another element. For example, a first user device and a second user device may indicate different user devices irrespective of an order or importance thereof. For example, a first element may be referred to as a second element, and similarly, a second element may be referred to as a first element without departing from the scope of the present disclosure.

When a certain element (e.g., the first element) is mentioned as being “operatively or communicatively coupled with/to” or “connected to” a different element (e.g., the second element), it is understood that the element is directly coupled with/to another element or may be coupled with/to the different element via another element (e.g., a third element). On the other hand, when the element (e.g., the first element) is mentioned as being “directly coupled with/to” or “directly connected to” the other element (e.g., the second element), it is understood that another element (e.g., the third element) is not present between the element and the other element.

The expression “configured to”, as used in the present disclosure may be interchangeably used with, for example, “suitable for”, “having the capacity to”, “designed to”, “adapted to”, “made to”, or “capable of” according to the situation. The term “configured to” may not imply only “specially designed to” in a hardware implementation. Instead, in certain situations, “a device configured to” may imply that the device is “capable of” together with other devices or components. For example, “a processor configured to perform A, B, and C” may imply a dedicated processor (e.g., an embedded processor) for performing a corresponding operation or a general-purpose processor (e.g., central processing unit (CPU) or an application processor) capable of performing corresponding operations by executing one or more software programs stored in a memory device.

The terms used in the present disclosure are for the purpose of describing particular embodiments only and do not limit other embodiments. A singular expression may include a plural expression unless there is a contextually distinctive difference. Unless otherwise defined, all terms (including technical and scientific terms) used herein have the same meaning as commonly understood by those ordinarily skilled in the art to which various embodiments of the present disclosure belong. It should be further understood that terms, such as those defined in commonly used dictionaries, should be interpreted as having a meaning that is consistent with their meaning in the context of the relevant art, and should not be interpreted in an idealized or overly formal sense unless expressly defined herein. Additionally, the terms defined in the present disclosure should not be interpreted to exclude the various embodiments of the present disclosure.

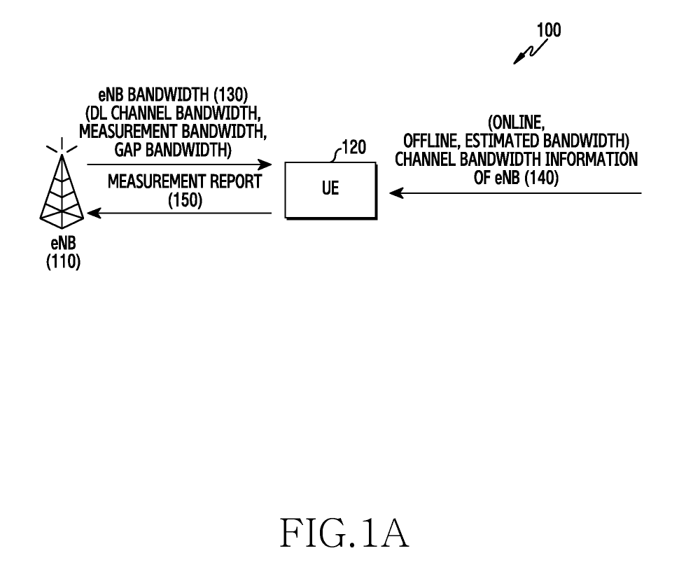

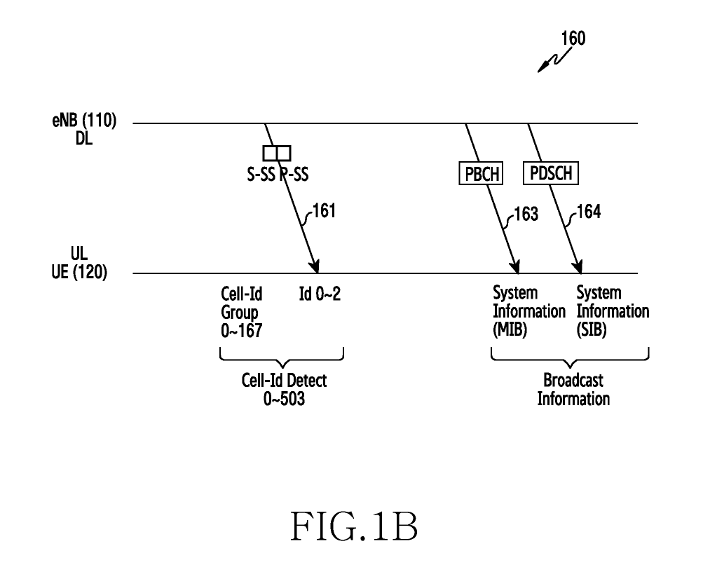

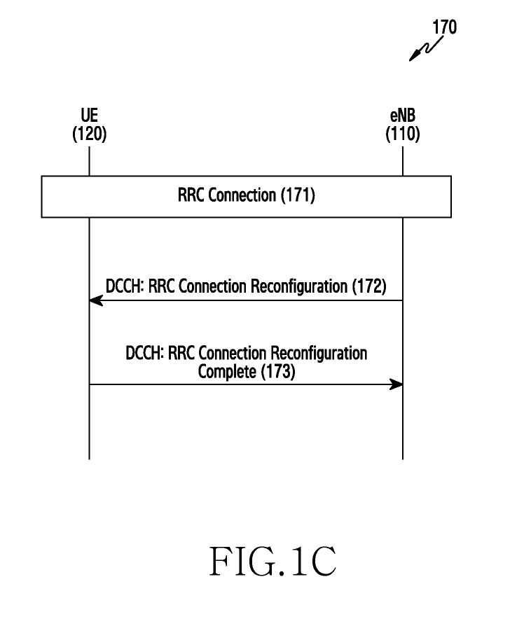

FIG. 1A illustrates a cellular communication network, according to an embodiment of the present disclosure.

Referring to FIG. 1A, the cellular communication network 100 includes an eNB 110 and a UE 120. The eNB 110 may be a serving eNB capable of communicating with the UE 120. The cellular communication network 100 may further include a plurality of first neighboring eNBs near the UE 120 and a plurality of second neighboring eNBs of another cellular communication network. Herein, the cellular communication network 100 may include a global system for mobile communications (GSM) network or a wide code division multiple access (WCDMA) network, and the other cellular communication network may include a long term evolution (LTE) network or an LTE advanced (LTE-A) network.

According to an embodiment of the present disclosure, the cellular communication network 100 may include the LTE network or the LTE-A network, and the other cellular communication network may include the GSM network or the WCDMA network.

The UE 120 in connected mode or in idle mode may measure received signals of the serving eNB 110 and the neighboring eNBs or the other cellular network based on a relevant bandwidth on a periodic basis or at a particular time determined through negotiation with the eNB, and report a measurement result to the eNB 110 in step 150. The measurement result may be used for at least one of cell reselection, handover, transmit power control, downlink (DL) scheduling, and uplink (UL) scheduling. The received signal measurement value may include at least one of reference symbol received power (RSRP), received signal strength indicator (RSSI), and reference symbol received quality (RSRQ). The RSSI may indicate a total power value of the received signal including any interference and thermal noise, and the RSRP may indicate an average power of all of resource blocks (RBs) in a measurement bandwidth. The RSRQ may be defined as RSRP/(RSSI/N). Herein, N denotes the number of resource blocks (RBs) corresponding to the measurement bandwidth.

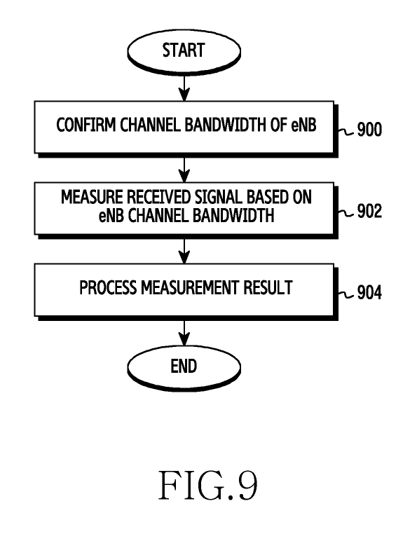

For example, the UE 120 may carry out intra-frequency measurement, inter-frequency measurement, and inter-radio access technology (RAT) measurement, based on measurement bandwidth methods described in FIG. 9 through FIG. 23. The intra-frequency measurement measures a received signal in the same center frequency, the inter-frequency measurement measures a received signal of a different center frequency, and the inter-RAT measurement measures a received signal of a cellular network using a different communication scheme (for example, third generation (3G) communication such as GSM or WCDMA) than LTE services. Alternatively, the inter-RAT measurement may measure a received signal of an LTE system or the 3G s such as GSM or WCDMA.

The bandwidth for the received signal measurement may be determined based on a bandwidth 130 determined by the eNB such as a DL channel bandwidth, a measurement bandwidth, and a gap bandwidth of the serving eNB, and a channel bandwidth or an estimated channel bandwidth 140 of the first and second neighboring eNBs obtained from a database.

The eNB 110 may send its configuration parameters including the DL channel bandwidth 130, to the UE 120 using a broadcast message. The eNB 110 may send a separate dedicated message including the measurement bandwidth or the gap bandwidth 130, to the UE 120. The gap bandwidth information 130 may be sent to the UE 120 by a broadcast message.

The UE 120 receives the bandwidth information (e.g., the DL channel bandwidth, the measurement bandwidth, and the gap bandwidth of the serving eNB) from the eNB 110. The UE 120 may receive channel bandwidth information of the first and second neighboring eNBs from an online or offline database. For example, the UE 120 may download the channel bandwidth information of the first and second neighboring eNBs from a server over the Internet. The UE 120 may receive the channel bandwidth information of the first and second neighboring eNBs from the eNB 110.

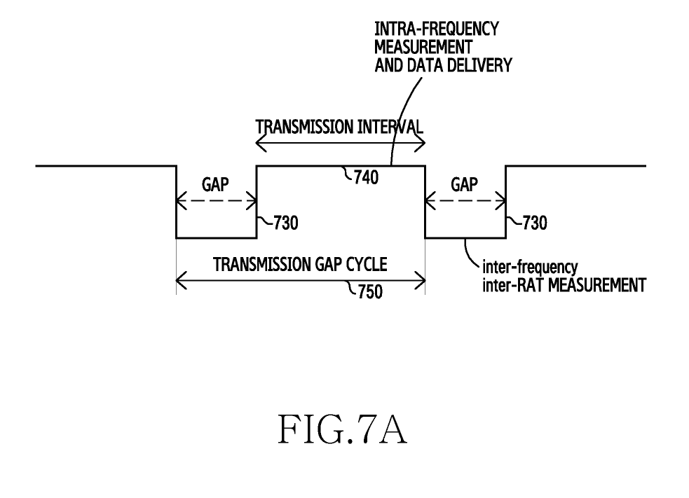

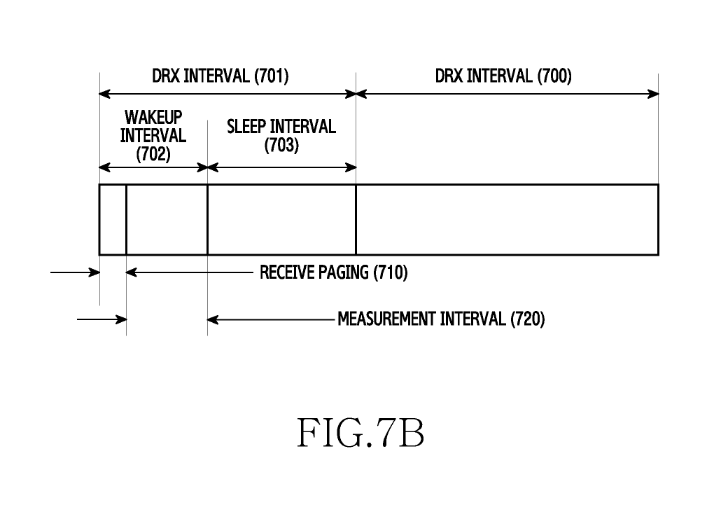

The channel bandwidth information may include channel bandwidth information corresponding to evolved universal terrestrial radio access (EUTRA) absolute radio frequency channel number (EARFCN) used by the eNB in the cellular communication network 100 and the other cellular communication network. For example, each EARFCN indicates the center frequency of the DL channel and the UL channel which are different from each other. The eNBs may use the same or different EARFCNs. Accordingly, the channel bandwidth information may include channel bandwidths of all of the eNBs in the cellular communication network 100 and the other cellular communication network. Herein, the channel bandwidth indicates a transmit bandwidth of a radio frequency (RF) carrier used by the eNB to send a signal. The gap bandwidth indicates a frequency bandwidth used in a gap for the inter-frequency measurement or the inter-RAT measurement of FIG. 7A.

The channel bandwidth information may include channel bandwidths of neighboring eNBs based on the location of the UE 120. Neighboring eNB information may be sent to the UE 120 using a broadcast message of the eNB 110. The UE 120 may obtain necessary channel bandwidths of the neighboring eNBs based on the neighboring eNB information.

The UE 120 may replace one of the bandwidth 130 determined by the eNB 110, the eNB channel bandwidth obtained from the database, and the estimated eNB channel bandwidth 140, with the measurement bandwidth.

FIG. 1B illustrates synchronization 160 between an eNB and a UE, according to an embodiment of the present disclosure.

Referring to FIG. 1B, the UE 120 may obtain a half-frame boundary and a primary identity (PID) 0˜2 by detecting a primary synchronization signal (PSS), and obtain a frame boundary and a secondary ID (SID) 0˜167 by detecting a secondary synchronization signal (SSS) in step 161. The UE 120 may obtain a cell ID using the PID and the SID. Next, the UE 120 may receive a master information block (MIB) including requisite system information of the eNB such as a DL channel bandwidth, over a physical broadcast channel (PBCH) in step 163. The MIB may be delivered using the PBCH at preset intervals (e.g., 40 ms). The UE 120 may receive system information blocks (SIBs) over a physical downlink shared channel (PDSCH) in step 164. SIB1 may include network identification information such as a public land mobile network (PLMN) ID, a tracking area ID, and a cell ID, and time domain scheduling information of other SIBs. SIB2 may include information (e.g., UL cell bandwidth, random access parameter, UL power control parameter) required for a terminal to access a cell. SIB3 may include cell reselection information, SIB4-SIB8 may include neighboring cell information, SIB9 may include a home eNB (HeNB) name, SIB10-SIB12 may include public warning messages, and SIB 13 may include important information for multimedia broadcast multicast service (MBMS) reception. The SIBs may be transmitted over the PDSCH at preset intervals.

FIG. 1C illustrates RRC connection reconfiguration 170 between an eNB and a UE, according to an embodiment of the present disclosure.

Referring to FIG. 1C, the UE 120 and the eNB 110 may configure RRC connection 171 to exchange control information during an initial access. The UE 120 and the eNB 110 may perform various RRC procedures to exchange necessary configuration information for radio resource management in an RRC layer. An RRC message may include control messages from non-access stratum (NAS) protocol.

To establish/modify/release radio bearers, to handover, to setup/modify/release the measurement, or to deliver dedicated NAS information from the eNB to the UE, the eNB 110 may send an RRC connection reconfiguration message 172 to the UE 120.

In response to the RRC connection reconfiguration message, the UE 120 may send an RRC connection reconfiguration complete message 173 to the eNB 110. The RRC connection reconfiguration message and the RRC connection reconfiguration complete message may be transmitted by mapping the messages to the physical dedicated control channel (PDCCH).

A measurement related field (MeasObjectEUTRA) of the RRC connection reconfiguration message may deliver the measurement bandwidth information.

The broadcast channel may deliver the DL channel bandwidth of the eNB, and the dedicated control channel may deliver the measurement bandwidth information. The received signal may be measured based on the measurement bandwidth delivered by the RRC connection reconfiguration message.

Measurement performance of the UE 120 may be affected by sizes of the measurement bandwidth and the channel bandwidth of the eNB.

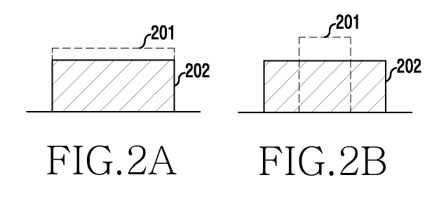

FIGS. 2A and 2B illustrate a relationship between an eNB channel bandwidth and a measurement bandwidth, according to an embodiment of the present disclosure.

In FIG. 2A, a measurement bandwidth 201 is the same as an eNB channel bandwidth 202. In FIG. 2B, the measurement bandwidth 201 is narrower than the eNB channel bandwidth 202.

Measurement of the bandwidth according to FIG. 2B may exhibit lower accuracy and reliability than measurement of the bandwidth according to FIG. 2A. For example, as the measurement bandwidth increases, the number of resource elements or cell reference signals (CRSs) relating to the received signal measurement increases. As a result, the accuracy and the reliability of the measurement values such as RSSI, RSRP, or RSRQ may rise. When the measurement bandwidth is narrower than the channel bandwidth, the number of resource elements or CRSs relating to the received signal measurement decreases and thus the accuracy and reliability of the measurement values such as RSSI, RSRP, or RSRQ may decrease.

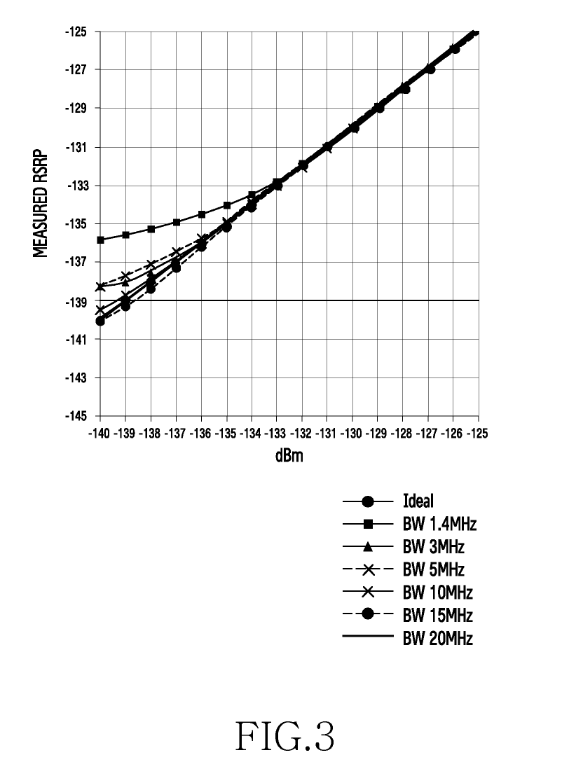

FIG. 3 is a graph illustrating estimated RSRP based on a measurement bandwidth, according to an embodiment of the present disclosure.

Referring to FIG. 3, the horizontal axis indicates dBm based on a real channel environment, and the vertical axis indicates the measured RSRP.

Ideally, dBm based on the real channel environment matches the measured RSRP value.

As the measurement bandwidth narrows, accuracy and reliability of the estimated RSRP may fall. As the bandwidth measured in the channel bandwidth widens, the accuracy and reliability of the estimated RSRP may rise. For example, in the channel bandwidth of 20 MHz, the measurement with the measurement bandwidth of 20 MHz may yield higher accuracy and reliability than the measurement with the measurement bandwidth of 1.4 Mhz.

Hence, the present disclosure may enhance the measurement accuracy and reliability by measuring with the DL channel bandwidth of the MIB delivered over the PBCH of FIG. 1B, instead of the measurement bandwidth information of the RRC connection reconfiguration message of FIG. 1C.

An electronic device (e.g., the UE 120 of FIG. 1) according to various embodiments of the present disclosure, may include at least one of a smart phone, a tablet personal computer (PC), a mobile phone, a video phone, an e-book reader, a desktop PC, a laptop PC, a netbook computer, a workstation, a server, a personal digital assistant (PDA), a portable multimedia player (PMP), a moving picture experts group (MPEG)-1 audio layer 3 (MP3) player, a mobile medical device, a camera, and a wearable device (e.g., smart eyeglasses, a head-mounted-device (HMD), electronic clothes, an electronic bracelet, an electronic necklace, an electronic accessory, an electronic tattoo, a smart mirror, or a smart watch).

According to various embodiments of the present disclosure, the electronic device may be a smart home appliance. For example, the smart home appliance may include at least one of a television (TV), a digital video disk (DVD) player, an audio device, a refrigerator, an air conditioner, a cleaner, an oven, a microwave oven, a washing machine, an air purifier, a set-top box, a home automation control panel, a security control panel, a TV box (e.g., Samsung HomeSync™, Apple TV™, or Google TV™), a game console (e.g., Xbox™, PlayStation™), an electronic dictionary, an electronic key, a camcorder, and an electronic picture frame.

According to various embodiments of the present disclosure, the electronic device may include at least one of various medical devices (e.g., various portable medical measurement devices (i.e., a blood glucose monitoring device, a heart rate monitoring device, a blood pressure measuring device, a body heat measuring device, etc.), magnetic resonance angiography (MRA), magnetic resonance imaging (MRI), computed tomography (CT), imaging equipment, ultrasonic instrument, etc.), a navigation device, a global positioning system (GPS) receiver, an event data recorder (EDR), a flight data recorder (FDR), a car infotainment device, electronic equipment for a ship (e.g., a vessel navigation device, a gyro compass, etc.), avionics, a security device, a vehicle head unit, an industrial or domestic robot, an automatic teller machine (ATM), a point of sales (POS) terminal, and devices associated with the Internet of things (IoT) (e.g., a light bulb, various sensors, an electric or gas meter, a sprinkler device, a fire alarm, a thermostat, a streetlamp, a toaster, fitness equipment, a hot water tank, a heater, a boiler, etc.).

According to various embodiments of the present disclosure, the electronic device may include at least one of furniture, a part of a building/construction, an electronic board, an electronic signature receiving device, a projector, and various measurement machines (e.g., water supply, electricity, gas, propagation measurement machine, etc.). The electronic device may be one or more combinations of the aforementioned various devices. The electronic device may be a flexible device. In addition, the electronic device is not limited to the aforementioned devices, and may include a new electronic device based on technical advances.

In the present disclosure, the term ‘user’ may refer to a person who uses the electronic device or a device which uses the electronic device (e.g., an artificial intelligence (AI) electronic device).

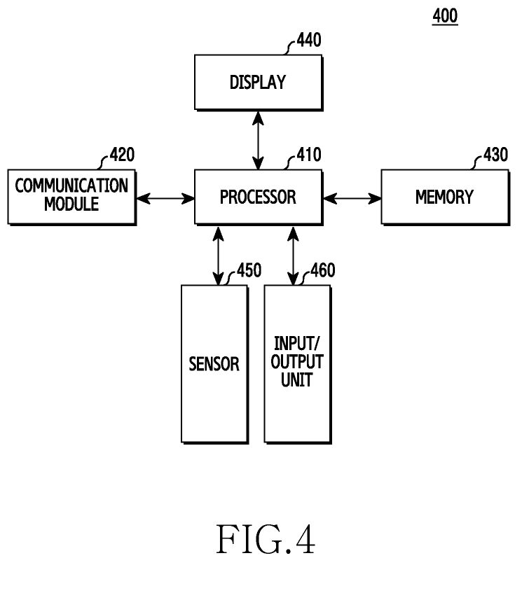

FIG. 4 is a block diagram of an electronic device, according to an embodiment of the present disclosure.

Referring to FIG. 4, the electronic device 400 includes a processor 410, a communication module 420, a memory 430, a display 440, a sensor module 450, and an input/output unit 460. The electronic device 400 may include a camera module and a power supply unit (e.g., a battery). The electronic device 400 is not limited to the components of FIG. 4. The electronic device 400 may include more components or omit some components of FIG. 4.

The communication module 420 may include one more modules for radio communication between the electronic device 400 and a wireless communication system or between the electronic device 400 and another electronic device. For example, the communication module 420 may include a mobile communication module, a wireless local area network (WLAN) module, a short-range communication module, a location calculation module, a broadcasting reception module, and the like. The communication module 420 may adaptively determine the measurement bandwidth based on a radio environment, and perform the intra-frequency measurement, the inter-frequency measurement, and the inter-RAT measurement.

The mobile communication module of the communication module 420 may send and receive radio signals to and from at least one of an eNB, an external electronic device, and various servers (e.g., an integration server, a provider server, a content server, an Internet server, or a cloud server) over the network. The radio signal may include a voice call signal, a video call signal, or various data according to text/multimedia message delivery.

The mobile communication module of the communication module 420 may receive data (e.g., content, messages, mails, images, videos, weather information, location information, time information, or frame information). The mobile communication module may receive various data from at least one other electronic device connected to the electronic device 400 over a network (e.g., a mobile communication network). The mobile communication module may send various data (e.g., channel bandwidth information of eNBs) required for the operation of the electronic device 400, to a server or another electronic device in response to a user request.

The mobile communication module of the communication module 420 may provide a communication function. For example, the mobile communication module of the communication module 420 may convert an RF signal to a baseband signal and provide the baseband signal to the processor 410, or convert a baseband signal from the processor 410 to an RF signal and transmit the RF signal, under control of the processor 410. Herein, the processor 410 may process the baseband signal based on various communication schemes. For example, the communication schemes may include, but not limited to, a global system for mobile communications (GSM) communication scheme, an enhanced data GSM environment (EDGE) communication scheme, a code division multiple access (CDMA) communication scheme, a WCDMA communication scheme, an LTE communication scheme, or an orthogonal frequency division multiple access (OFDMA) communication scheme.

The WLAN module of the communication module 420 may establish a wireless Internet connection and a WLAN link with other electronic devices. The WLAN module of the communication module 420 may be mounted inside or outside the electronic device 400. The wireless Internet technique may employ WLAN, wireless fidelity (WiFi), wireless broadband (Wibro), world interoperability for microwave access (WiMAX), high speed downlink packet access (HSDPA), or millimeter wave (mmWave).

The WLAN module of the communication module 420 may send or receive data selected by a user, to or from the outside. In association with at least other electronic device (e.g., a communication relay device) and a server connected to the electronic device 400 over a network (e.g., the wireless Internet network), the WLAN module of the communication module 420 may send or receive various data (e.g., channel bandwidth information of eNBs) of the electronic device 400 to or from the outside (e.g., the communication relay device or the server). The WLAN module of the communication module 420 may be turned on all the time, or turned on according to settings of the electronic device 400 or a user input.

The short-range communication module of the communication module 420 may perform short-range communication. The short-range communication may include Bluetooth, Bluetooth low energy (BLE), radio frequency identification (RFID), infrared data association (IrDA), ultra wideband (UWB), Zigbee, or near field communication (NFC).

The short-range communication module of the communication module 420 may receive data. In association with other electronic device connected to the electronic device 400 over a network (e.g., the short-range communication network), the short-range communication module of the communication module 420 may send or receive various data of the electronic device 400 to or from other electronic devices. The short-range communication module of the communication module 420 may be turned on all the time, or turned on according to the settings of the electronic device 400 or a user input.

The location calculation module of the communication module 420 obtains a location of the electronic device 400. For example, the location calculation module may include a GPS module. The location calculation module of the communication module 420 may measure the location of the electronic device 400 using triangulation. For example, the location calculation module of the communication module 420 may calculate distance information and time information from three or more eNBs, apply trigonometry to the calculated information, and thus calculate current location information in three dimensions based on latitude, longitude, and altitude. Alternatively, the location calculation module may calculate location information by constantly receiving location information of the electronic device 400 from three or more eNBs. The location information of the electronic device 400 may be obtained by various methods.

The broadcasting reception module of the communication module 420 may receive a broadcasting signal (e.g., a TV broadcasting signal, a radio broadcasting signal, a data broadcasting signal, and the like) and/or broadcasting information (e.g., broadcast channel, broadcasting program, or broadcasting service provider information) from an external broadcasting management server over a broadcast channel (e.g., a satellite broadcast channel, a terrestrial broadcast channel, and the like).

The display 440 may serve as an input/output means for inputting and displaying data at the same time. The display 440 may provide an input/output interface between the electronic device 400 and the user, forward a user's touch input to the electronic device 400, and display an output from the electronic device 400 to the user. The display 440 may display a visual output to the user. The visual output may include text, graphic, video, and their combination. For example, the display 440 may display various screens according to the operation of the electronic device 400. The various screens may include, for example, a messenger screen, a call screen, a game screen, a video play screen, a gallery screen, a webpage screen, a home screen, and a network connection screen.

The display 440 may detect an event (e.g., a touch event, a hovering event, an air gesture event) based on at least one of touch, hovering, and air gesture from the user, and send an input signal of the event to the processor 410. The processor 410 may identify the received event and control the operation according to the identified event.

The display 440 may display (output) various information processed in the electronic device 400. For example, when the electronic device 400 is in a call mode, the display 440 may display a user interface (UI) or a graphical UI (GUI) in relation to the call. When the electronic device 400 is in a video call mode or in a camera mode, the display 440 may display a UI or a GUI relating to a captured and/or received image and the corresponding mode. The display 440 may display data of the electronic device 400, content, or information of other electronic devices (e.g., a communication relay device) connected via the network. The display 440 may display various application screens corresponding to an application executed.

The display 440 may support landscape screen display and portrait screen display based on a rotation direction (or orientation) of the electronic device 400, or screen display based on the transition between the landscape mode and the portrait mode. The display 440 may employ various displays. Some displays may be implemented using a transparent or optically transparent display.

The display 440 may detect a user input touching or approaching the display. The user input may include a touch event or a proximity event which is input based on at least one of a single touch, multi-touch, hovering, or air gesture. For example, the user input may be applied using tap, drag, sweep, flick, drag and drop, or drawing gesture (e.g., writing). The display 440 may detect the user input (e.g., the touch event or the proximity event), generate a signal corresponding to the detected user input, and send the generated signal to the processor 410. According to the signal fed from the display 440, the processor 410 may control to execute a function corresponding to a region of the user input (e.g., the touch event or the proximity event).

The display 440 may receive a user input for initiating an operation for using the electronic device 400, and issue an input signal according to the user input. The display 440 may convert a change such as pressure or capacitance at a particular point, to an electric input signal. The display 440 may detect a location and an area touched or approached by an input means (e.g., a user finger, a digital pen, and the like). The display 440 may detect an event such as touch pressure according to the adopted touch type. In response to the touch or proximity input, the display 440 may forward corresponding signal(s) to a touch screen controller. The touch screen controller may process the signal(s) and send corresponding data to the processor 410. Hence, the processor 410 may determine which part of the touch screen is touched or approached, and execute a corresponding function.

The input/output unit 460 may generate input data for controlling the electronic device 400, in response to the user input. The input/output unit 460 may include at least one input means for detecting user's various inputs. For example, the input/output unit 460 may include a key pad, a dome switch, a physical button, a touchpad (resistive/capacitive), jog & shuttle buttons, and the like.

Part of the input/output unit 460 may be implemented using a button on the outside surface of the electronic device 400, or the entire or part of the input/output unit 460 may be implemented using a touch panel. The input/output unit 460 may receive a user input for initiating the electronic device 400, and issue an input signal according to the user input. For example, the input/output unit 460 may receive various user inputs to connect to a communication relay device, to capture an image, to execute an application, to input (write, insert) data, to change a posture of the electronic device 400, to display content, and to send or receive data, and issue an input signal according to the user input.

The input/output unit 460 may forward an audio signal from the processor 410 to a speaker (SPK), and forward an audio signal, such as voice, from a microphone (MIC) to the processor 410. Under control of the processor 410, the input/output unit 460 may convert voice/sound data to an audible sound and output the audible sound through the speaker, and convert an audio signal, such as voice, from the microphone to a digital signal and send the digital signal to the processor 410. The input/output unit 460 may output an audio signal corresponding to a user input according to audio processing information (e.g., a sound effect, a music file, etc.).

The speaker may output audio data received from the communication module 420 or stored in the memory 430. The speaker may output a sound signal relating to various operations (functions) of the electronic device 400. The speaker may process audio stream output such as voice recognition, voice reproduction, digital recording, and calling function. The speaker may include an attachable and detachable earphone, headphone, or headset, and may be connected to the electronic device 400 through an external port.

The microphone may receive and process an external sound signal as electric voice data. When the electronic device 400 is in the call mode, the voice data processed by the microphone may be converted to be transmitted through the communication module 420. The microphone may adopt various noise reduction algorithms to reduce noise in the external sound signal input. The microphone may process audio stream inputs such as voice command (e.g., voice command to initiate the connection between the electronic device 400 and the communication relay device), voice recognition, digital recording, and calling function. For example, the microphone may convert a voice signal to an electric signal. The microphone may include an internal microphone embedded in the electronic device 400 and an external microphone connected to the electronic device 400.

The memory 430 may store one or more programs executed by the processor 410, and may temporarily store input/output data. The input/output data may include, for example, various identification information (e.g., temporary mobile subscriber identity (TMSI), packet-TMSI (P-TMSI), international mobile subscriber identity (IMSI) such as mobile country code (MCC) or mobile network code (MNC) information), international mobile station equipment identity (IMEI)), channel information (e.g., paging channel information), content, messenger data (e.g., text data), contact information (e.g., a landline or mobile phone number), messages, media files (e.g., audio, video, and image files), and bandwidth information (e.g., the measurement bandwidth, the channel bandwidths of the eNBs, a reference bandwidth, and the gap bandwidth).

The memory 430 may store one or more programs and data for controlling the reduction of power consumed by the electronic device 400. For example, the memory 430 may store one or more programs and corresponding data for connecting with the communication relay device, sending forwarding information (e.g., identity information, channel information) to the connected communication relay device, determining whether the electronic device 400 enters the sleep mode, and, when entering the sleep mode, notifying the sleep mode entry of the electronic device 400 to the communication relay device.

The memory 430 may also store usage frequency (e.g., communication relay device connection frequency, application usage frequency, content usage frequency, and the like), importance, and priority according to the operation of the electronic device 400. The memory 430 may store various vibration and sound patterns which are output in response to the touch input or the proximity input on the display 440. The memory 430 may store permanently or temporarily an operating system (OS) of the electronic device 400, input and display control programs using the display 440, a program for controlling various operations (functions) of the electronic device 400, and various data generated in the operations of the programs.

The memory 430 may include an extended memory (e.g., an external memory) or an internal memory (e.g., an embedded memory). The electronic device 400 may operate in association with a web storage which stores memory 430 on the Internet.

The memory 430 may store various software. For example, software components may include an OS software module, a communication software module, a graphic software module, a user interface software module, an MPEG module, a camera software module, or one or more application software modules. The module being the software component may be represented as a set of instructions, and thus may be referred to as an instruction set. The module may be also referred to as a program. The memory 430 may include another module (instructions) in addition to the above-stated modules. Alternatively, the memory 430 may not use some module (instructions).

The OS software module may include various software components for controlling general system operations. The general system operation control may include, for example, memory management and control, storage hardware (device) control and management, and power control and management. The OS software module may also enable smooth communication between various hardware devices and the software component (module).

The communication software module may enable communication with other electronic devices such as a wearable device, a communication relay device, a computer, a server, or a portable terminal, through the communication module 420. The communication software module may conform to a protocol structure corresponding to the communication scheme.

The graphic software module may include various software components for providing and displaying graphics on the display 440. The graphics may include text, web pages, icons, digital images, videos, animations, and the like.

The user interface software module may include various UI software components. For example, the user interface software module may define how the UI changes or which condition changes the UI.

The MPEG module may include a software component for enabling digital content (e.g., video, audio) process and functions (e.g., contents creation, production, distribution, and transmission).

The camera software module may include a camera related software component allowing camera related processes and functions.

The application module may include a web browser, a rendering engine, an e-mail application, an instant message application, a word processor, keyboard emulation, an address book, a touch list, a widget, digital rights management (DRM), voice recognition, a position determining function, and a location based service. The application module may include instructions for establishing the connection with the communication relay device. For example, when the electronic device 400 enters the sleep mode, the application module may notify sleep mode transition information to the communication relay device and stay in the sleep mode until paging is received from the communication relay device in the sleep mode of the electronic device 400.

An interface unit may interface with any external device connected to the electronic device 400. The interface unit may receive data or power from an external device and provide the data or power to the components of the electronic device 400, or send data from the electronic device 400 to an external device. For example, the interface unit may include, a wired/wireless headset port, an external charger port, a wired/wireless data port, a memory card port, a port for connecting to a device including an identity module, an audio input/output port, a video input/output port, and an earphone port.

A camera module supports the camera function of the electronic device 400. The camera module may capture an image (a still image or a moving image) of an object. The camera module may capture image data under control of the processor 410 and send the captured image data to the display 440 and the processor 410. The camera module may include an image sensor (or a camera sensor) for converting an input optical signal to an electric signal, and an image signal processor for converting the electric signal from the image sensor to digital image data. The image sensor may include a sensor using a charge-coupled device (CCD) or a complementary metal-oxide-semiconductor (CMOS). Additionally or alternatively, the camera module may include, for example, a color sensor which identifies a color by detecting a light wavelength radiated or reflected by an object. The camera module may support an image processing function to support the capturing with various camera options (e.g., zooming, aspect ratio, effects (e.g., sketch, mono, sepia, vintage, mosaic, frame, etc.)) according to the user settings.

The processor 410 may control the operations of the electronic device 400. For example, the processor 410 may control voice communication, data communication, and video communication. The processor 410 may include one or more processors. For example, the processor 410 may include a communication processor (CP), an application processor (AP), an interface (e.g., general purpose input/output (GPIO)), or an internal memory, as separate components or may integrate them on one or more integrated circuits. The AP may perform various functions for the electronic device 400 by executing various software programs, and the CP may process and control voice communication and data communication. The processor 410 may execute a particular software module (e.g., an instruction set) stored in the memory 430 and carry out various functions corresponding to the module.

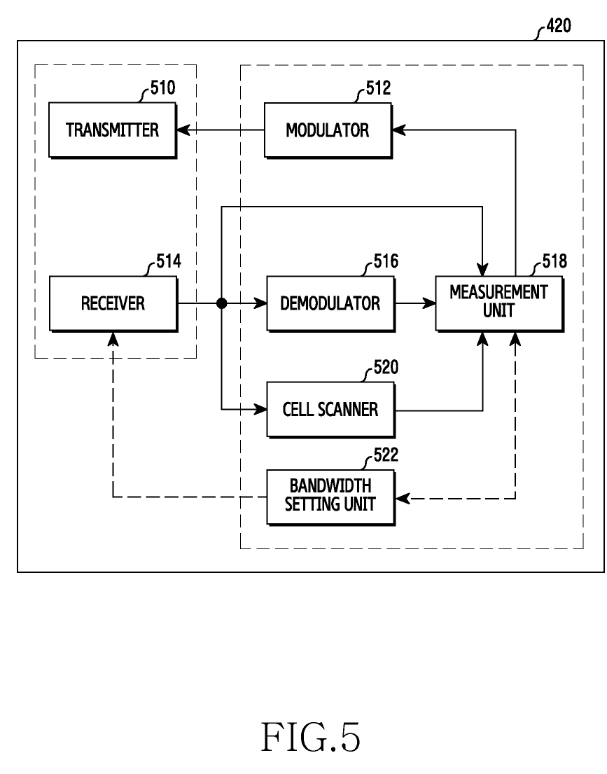

FIG. 5 is a block diagram of a communication device, according to an embodiment of the present disclosure.

Referring to FIG. 5, the communication module (or communication device) 420 includes a transmitter 510, a modulator 512, a receiver 514, a demodulator 516, a measurement unit 518, a cell scanner 520, and a bandwidth setting unit 522.

The modulator 512 may modulate a baseband signal corresponding to the received signal measurement value from the processor 410 of FIG. 4 or the measurement unit 518, based on various communication schemes. For example, the communication schemes may include, but are not limited to GSM communication, EDGE communication, CDMA communication, WCDMA communication, LTE communication, LTE-A communication and OFDMA communication.

For example, based on the LTE communication, the modulator 512 may include, but is not limited to, an M-point discrete fourier transform (DFT), a subcarrier allocator or mapper, an N-point inverse FFT (IFFT), a cyclic prefix (CP) adder, a parallel to serial (PS) converter, and a digital to analog converter (DAC). The modulator 512 may omit some components or include other components.

With a signal to transmit, the M-point DFT converts an input time-domain signal to a frequency-domain signal and outputs the frequency-domain signal to the subcarrier allocator or mapper. The subcarrier allocator or mapper maps the output signal from the M-point DFT, into a transmit frequency band, and outputs the signal to the N-point IFFT. The N-point IFFT IFFT-processes and outputs the output signal of the subcarrier allocator or mapper, to the CP adder. The CP adder adds a CP to the output signal of the N-point IFFT and outputs the signal to the PS converter. The PS converter converts the parallel signal output from the CP adder, to a serial signal and outputs the serial signal to the DAC. The DAC converts the digital signal output from the PS converter to an analog signal and outputs the analog signal to the transmitter 510.

The transmitter 510 may include a power amplifier and a frequency upconverter. The transmitter 510 may convert the analog signal modulated by the modulator 512, to an RF signal, amplify the RF signal, and output the amplified RF signal.

The receiver 514 may include a low noise amplifier (LNA) and a frequency downconverter. Using the LNA and the downconverter, the receiver 514 may amplify a received RF signal with low noise and convert the amplified RF signal to a baseband signal.

The demodulator 516 may demodulate the baseband signal from the receiver 514 based on various communication schemes, and output the demodulated signal to the processor 410 of FIG. 4 or the measurement unit 518. For example, the communication schemes may include, but are not limited to GSM communication, EDGE communication, CDMA communication, WCDMA communication, LTE communication, LTE-A communication and OFDMA communication.

For example, based on LTE communication, the demodulator 516 includes an analog to digital converter (ADC), a CP remover, a serial to parallel (SP) converter, an N-point FFT, a subcarrier deallocator, and an equalizer. The ADC converts an analog signal fed from the receiver 514 to a digital signal and outputs the digital signal to the CP remover. The CP remover removes the CP from the output signal of the ADC and outputs the signal to the SP converter. The SP converter converts a serial signal output from the CP remover to a parallel signal and outputs the parallel signal to the N-point FFT. The N-point FFT FFT-processes the output signal of the SP converter and outputs the signal to the subcarrier deallocator. The subcarrier deallocator demaps the output signal of the N-point FFT to a frequency-domain signal and outputs the signal to the equalizer. The equalizer compensates for signal distortion of the output signal of the subcarrier deallocator.

The measurement unit 518 measures eNBs identified by the cell scanner 520. For example, the measurement unit 518 may measure a received signal from the serving eNB or neighboring eNBs. More specifically, the measurement unit 518 may extract symbol signals corresponding to a reference signal from the demodulated signal of the demodulator 516, and measure the RSRP from the extracted symbol signals. The RSRP may be defined as a linear average of resource element (RE) power distribution including a cell-specific reference signal in the measurement bandwidth based on watts. The measurement unit 518 may measure the RSSI of the output signal from the receiver 514. For example, the measurement unit 518 may measure the RSSI of the output signal from the receiver 514. For example, the measurement unit 518 may measure the power of the received signal (with respect to every symbol) including interference and thermal noise. The measurement unit 518 may measure reference signal received quality (RSRP) based on the RSRP and the RSSI. The RSRQ may be defined as N×RSRP/(E-UTRA carrier RSSI), where N denotes the number of RBs in the measurement bandwidth of the E-UTRA carrier RSSI. Advantageously, both the numerator (RSRP) and the denominator (RSSI) of the RSRP definition should be measured in the same RB. The measurement value of the measurement unit 518 is not limited to the RSSI, the RSRP, and the RSRQ, and the measurement unit 518 may measure various measurement values.

The cell scanner 520 may identify a plurality of cells from the received signal of the receiver 514 using correlation in the frequency domain, or in the time domain, and provide the result to the measurement unit 518. For example, the received signal may include signals of the neighboring eNBs including the serving eNB. Hence, the cell scanner 520 may identify the serving eNB and the neighboring eNBs in the received signal. More specifically, the cell scanner 520 may detect PSS and SSS for the cell scanning.

The bandwidth setting unit 522 may determine the bandwidth for the received signal measurement using the channel bandwidth information, and control a parameter of the relevant component of the receiver 514 based on the determined bandwidth. For example, when determining the bandwidth 10 MHz for the received signal measurement, the bandwidth setting unit 522 may determine the FFT size to be 1024 corresponding to 10 MHz. When determining the bandwidth 5 MHz for the received signal measurement, the bandwidth setting unit 522 may determine the FFT size to be 512 corresponding to 10 MHz. Alternatively, the bandwidth setting unit 522 may determine the bandwidth of a receive filter as the received signal measurement bandwidth.

The bandwidth setting unit 522 may provide the determined measurement bandwidth and related information to the measurement unit 518. In so doing, the component of the receiver 514 may receive the received signal based on a maximum bandwidth (e.g., 20 MHz), and the measurement unit 518 may extract a measurement value corresponding to the received signal measurement bandwidth fed from the bandwidth setting unit 522, from the measurement result based on the maximum bandwidth (e.g., 20 MHz).

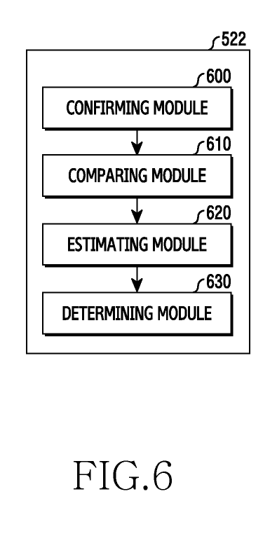

The bandwidth setting unit 522 is further described based on FIG. 6 through FIG. 16.

FIG. 6 illustrates a bandwidth setting unit, according to an embodiment of the present disclosure.

Referring to FIG. 6, the bandwidth setting unit 522 includes a confirming module 600, a comparing module 610, an estimating module 620, and a determining module 630.

The confirming module 600 may determine a first measurement or a second measurement. The first measurement may be intra-frequency measurement, and the second measurement may include one of inter-frequency measurement and inter-RAT measurement. For example, the communication device in connected mode may determine the first measurement or the second measurement according to a transmission interval 740 and a transmission gap 730 of FIG. 7A. In other words, the communication device may conduct intra-frequency measurement during the transmission interval 740 and conduct inter-frequency measurement and inter-RAT measurement during the transmission gap 730. The communication device in idle mode may perform the first measurement and the second measurement in a measurement interval 720 of a wakeup interval of FIG. 7B.

The confirming module 600 may obtain information about a first bandwidth and a second bandwidth determined by the eNB, a gap bandwidth, a reference bandwidth, an estimated channel bandwidth of at least one neighboring eNB, and a channel bandwidth of at least one neighboring eNB obtained from the database. For example, the confirming module 600 may receive received signal measurement bandwidth (or measurement bandwidth) and channel bandwidth information from the serving eNB 110, or determine whether the memory 430 stores information about the measurement bandwidth and the channel bandwidth of the eNB received previously, the gap bandwidth, and an eNB channel bandwidth estimated previously. The first bandwidth may include a DL channel bandwidth of the eNB over the broadcast channel, and the second bandwidth may include the measurement bandwidth determined by the eNB over the dedicated control channel.

The gap bandwidth may include one of 1.4 MHz and 10 MHz. The channel bandwidth of the eNB may include one of 1.4 MHz, 3 MHz, 5 MHz, 10 MHz, 15 MHz, and 20 MHz. Likewise, the measurement bandwidth may include one of 1.4 MHz, 3 MHz, 5 MHz, 10 MHz, 15 MHz, and 20 MHz. The measurement bandwidth may be narrower than the channel bandwidth. The reference bandwidth is a predicted bandwidth satisfying the measurement quality. For example, when the UE uses the reference bandwidth, some measurement quality may be expected.

The serving eNB 110 may provide its channel bandwidth to the UE 120, and the channel bandwidth of the neighboring eNB may be provided to the UE 120 offline or online.

The comparing module 610 may compare the first bandwidth and the second bandwidth and provide the comparison result to the determining module 630. The comparing module 610 may compare the gap bandwidth with the reference bandwidth and provide the comparison result to the determining module 630. The comparing module 610 may compare the second bandwidth with the reference bandwidth according to the comparison of the gap bandwidth and the reference bandwidth, and provide the comparison result to the determining module 630.

According to an embodiment of the present disclosure, in the first measurement of a serving cell, the determining module 630 may determine the first bandwidth, instead of the second bandwidth, as the received signal measurement bandwidth. In the first measurement of a neighboring cell, the determining module 630 may determine a channel bandwidth of a first neighboring eNB as the received signal measurement bandwidth. The first neighboring eNB may be an eNB in the same cellular network as the serving eNB 110. When having no channel bandwidth information of the first neighboring eNB, the determining module 630 may determine the second bandwidth as the received signal measurement bandwidth.

According to another embodiment of the present disclosure, in the first measurement, when the first bandwidth is wider than the second bandwidth, the determining module 630 may determine the first bandwidth as the received signal measurement bandwidth. Alternatively, when the first bandwidth is the same as the second bandwidth, the determining module 630 may determine the first bandwidth (or the second bandwidth) as the received signal measurement bandwidth. When the first bandwidth is different from the second bandwidth, the determining module 630 may determine the first bandwidth as the received signal measurement bandwidth.

The confirming module 600 determines whether channel bandwidth information of a second neighboring eNB is received from the database or whether a channel bandwidth of the second neighboring eNB is estimated previously and stored in memory 430. For example, the communication device may determine whether the channel bandwidth of the second neighboring eNB provided from the database is stored in the memory 430 or whether the channel bandwidth previously estimated of the second neighboring eNB is stored in the memory 430. With the channel bandwidth information of the second neighboring eNB to measure, the determining module 630 may determine the received signal measurement bandwidth based on the information. For example, the determining module 630 may determine the channel bandwidth of the second neighboring eNB stored in the memory 430, as the received signal measurement bandwidth.

Without the channel bandwidth information of the second neighboring eNB to measure, the comparing module 610 may compare the gap bandwidth with the reference bandwidth and provide the comparison result to the determining module 630 and the estimating module 620. The comparing module 610 may compare the measurement bandwidth (the second bandwidth) with the reference bandwidth and provide the comparison result to the determining module 630 and the estimating module 620. When the gap bandwidth is equal to, or greater than, the reference bandwidth, the determining module 630 may determine the gap bandwidth as the received signal measurement bandwidth. When the gap bandwidth is smaller than the reference bandwidth and when the measurement bandwidth is greater than, or equal to, the reference bandwidth, the determining module 630 may determine the measurement bandwidth as the received signal measurement bandwidth. When the measurement bandwidth is smaller than the reference bandwidth, the determining module 630 may determine the estimated channel bandwidth of the second neighboring eNB as the received signal measurement bandwidth.

According to another embodiment of the present disclosure, when the gap bandwidth is equal to, or greater than, the reference bandwidth, the determining module 630 may determine the gap bandwidth as the measurement bandwidth. When the gap bandwidth is smaller than the reference bandwidth, the determining module 630 may estimate the channel bandwidth of the neighboring eNB.

According to another embodiment of the present disclosure, when the gap bandwidth is equal to, or greater than, the reference bandwidth, the determining module 630 may determine the gap bandwidth as the received signal measurement bandwidth. When the gap bandwidth is smaller than the reference bandwidth, the determining module 630 may determine the second bandwidth as the received signal measurement bandwidth.

According to another embodiment of the present disclosure, without channel bandwidth information of the second neighboring eNB to measure, the determining module 630 may determine the second bandwidth as the received signal measurement bandwidth.

The estimating module 620 may measure the received signal of the corresponding neighboring eNB using a plurality of bandwidths (e.g., 1.4 MHz, 3 MHz, 5 MHz, 10 MHz, 15 MHz, and 20 MHz). The plurality of the bandwidths may include all the available bandwidths in the system. The plurality of the bandwidths may include a plurality of bandwidths greater than the measurement bandwidth or the gap bandwidth. Based on a plurality of measurement values of the received signal of the corresponding neighboring eNB, the estimating module 620 may determine a first candidate bandwidth and second candidate bandwidths. The first candidate bandwidth may include the measurement bandwidth or the gap bandwidth. The estimating module 620 selects the greatest bandwidth from the second candidate bandwidths. That is, the communication device may determine the selected bandwidth as the channel bandwidth of the neighboring eNB to be measured.

FIG. 7A illustrates a transmission interval and a gap in a UE connected mode, according to an embodiment of the present disclosure.

Referring to FIG. 7A, a UE connected to an eNB in an LTE system scans its neighboring cells on a periodic basis or on a specific condition. It is possible to scan and measure different cells of the same frequency without service interruption. However, to scan cells of different frequencies, the UE temporarily disconnects from the current serving eNB, scans and measures neighboring cells (e.g., inter-frequency measurement and inter-RAT measurement). In so doing, the disconnection time interval is referred to as a transmission gap or a measurement gap, and is a service interruption time.

The inter-RAT measurement signifies that the UE served via a GSM network or a WCDMA network temporarily disconnects from the GSM or WCDMA network and measures an LTE network signal, or that the UE served via the LTE network temporarily disconnects from the LTE network and measures a signal of the GSM or WCDMA network.

According to a transmission gap cycle 750, the transmission gap 730 may periodically appear during the connection. The interval excluding the transmission gap 730 is referred to as the transmission interval 740. The transmission interval 740 delivers data and conducts the intra-frequency measurement. The inter-frequency measurement or the inter-RAT measurement may be conducted during the transmission gap 730. The eNB and the UE may operate based on an agreed bandwidth (hereafter, referred to as a gap bandwidth) in the transmission gap.

FIG. 7B illustrates discontinuous reception (DRX) in an idle mode, according to an embodiment of the present disclosure.

Referring to FIG. 7B, a DRX cycle (or interval) 701 is divided into a wakeup interval 702 and a sleep interval 703. During the wakeup interval 702, the UE in a wakeup state may receive a paging signal 710 or measure a neighboring cell 720 for cell selection. During the sleep interval 703, the power supply or clock signal is limited in the UE to reduce power consumption. During the paging interval 710, information is delivered indicating whether there are calls or data to be received by mobile terminals, and the UE may determine whether its paging identifier is contained in the received paging information.

During the measurement interval 720, the UE measures receive power of neighboring cells in order to determine cell reselection criteria. For example, during the cell measurement interval 720, the UE may measure RSRP, RSSI, and RSRQ of the received signals of the serving eNB and the neighboring eNBs.

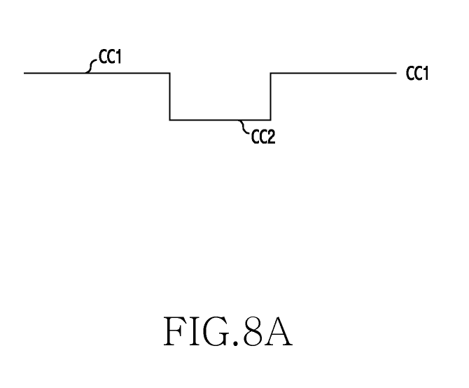

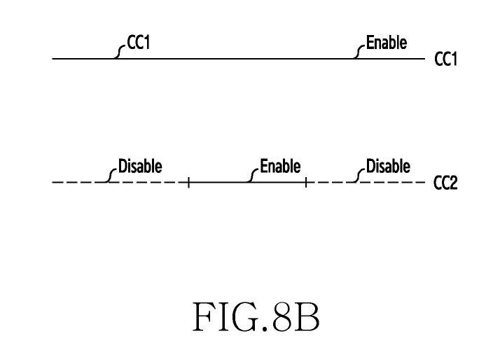

FIGS. 8A and 8B illustrate inter-frequency measurement when two component carriers (CC) are supported, according to an embodiment of the present disclosure.

Referring to FIG. 8A, during the service using a first CC, the inter-frequency measurement may be conducted on a second CC during the gap interval.

Referring to FIG. 8B, a UE supporting two CCs may be served using the first CC and perform the inter-frequency measurement using a path of the second CC. For example, a block for providing the second CC of the UE may transition from a disables state to an enables state and conduct the inter-frequency measurement. After the inter-frequency measurement is completed, the block for processing the second CC of the UE may transition from the enabled state to the disabled state.

FIG. 9 is a flowchart of a method for measuring a received signal in a UE, according to an embodiment of the present disclosure.

Referring to FIG. 9, the communication device confirms the channel bandwidth of the eNB in step 900. The serving eNB may send its channel bandwidth to the communication device via the serving eNB over the broadcast channel. The database may provide channel bandwidth information of neighboring eNBs to the communication device offline or online.

In step 902, the communication device measures a received signal based on the confirmed channel bandwidth of the eNB. For example, in the intra-frequency measurement, the communication device may measure the serving eNB using the channel bandwidth of the serving eNB and measure a first neighboring eNB using a channel bandwidth of the first neighboring eNB. For the intra-frequency measurement, the communication device may compare the channel bandwidth of the serving eNB with the channel bandwidth of the first neighboring eNB and measure the serving eNB and the first neighboring eNB using the smaller channel bandwidth. Without knowing the channel bandwidth of the first neighboring eNB, the communication device may measure the first neighboring eNB using a measurement bandwidth received over the dedicated control channel. The first neighboring eNB is an eNB near the serving eNB using the same frequency as the serving eNB.

For the inter-frequency measurement, the communication device may measure a second neighboring eNB using a channel bandwidth of the second neighboring eNB. The second neighboring eNB is an eNB near the serving eNB using a different frequency or a different wireless technique from the serving eNB.

Without knowing the channel bandwidth of the second neighboring eNB, the communication device may measure the second neighboring eNB using the gap bandwidth which is greater than, or equal to, the reference bandwidth. When the gap bandwidth is smaller than the reference bandwidth and the measurement bandwidth received over the dedicated control channel is greater than, or equal to, the reference bandwidth, the communication device may measure the second neighboring eNB using the measurement bandwidth. When the measurement bandwidth is smaller than the reference bandwidth, the communication device may estimate the channel bandwidth of the second neighboring eNB and then measure the second neighboring eNB using the estimated channel bandwidth of the second neighboring eNB.

In step 904, the communication device processes the measurement result. For example, the communication device may report the measurement result to the serving eNB 110 through the transmitter. Based on the measurement result, the communication device may perform the cell selection or the handover. The communication device may display the measurement result on the display 440 under control of the processor 410.

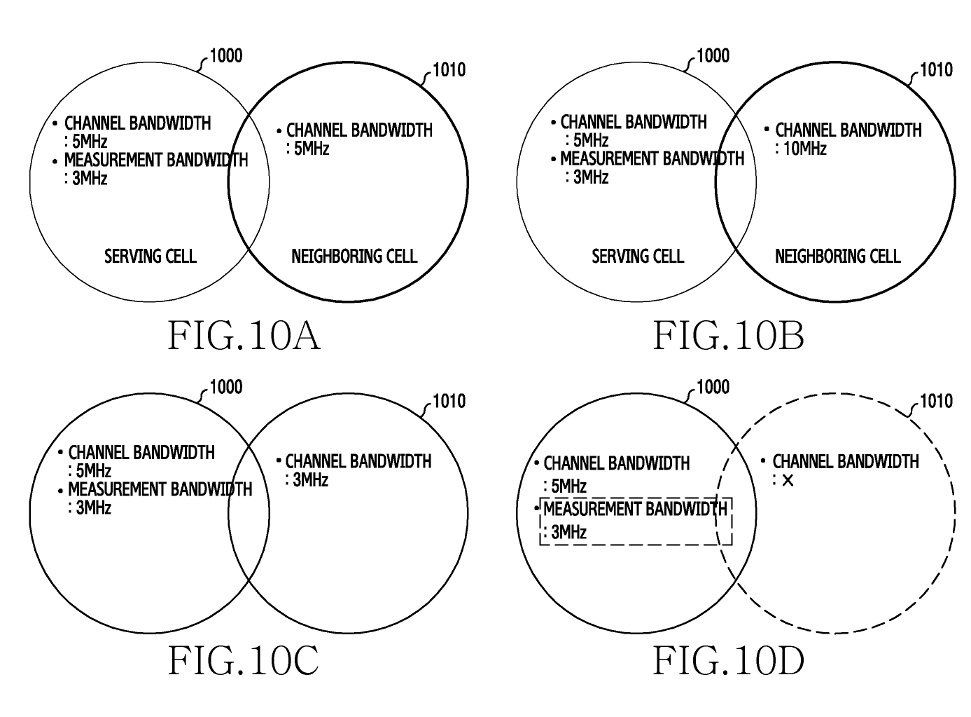

FIGS. 10A through 10D illustrate intra-frequency measurement, according to an embodiment of the present disclosure.

In FIG. 10A, when a channel bandwidth (or a first bandwidth) of a serving eNB 1000 is 5 MHz, a measurement bandwidth (or a second bandwidth) is 3 MHz, and a channel bandwidth of a first neighboring eNB 1010 is 5 MHz, a communication device in a serving cell is assumed to obtain channel bandwidth information of the first neighboring eNB 1010 from the database offline or online. The communication device may measure signals of the serving eNB 1000 and the first neighboring eNB 1010 with the bandwidth 5 MHz.

In FIG. 10B, when the channel bandwidth (or the first bandwidth) of the serving eNB 1000 is 5 MHz, the measurement bandwidth (or the second bandwidth) is 3 MHz, and the channel bandwidth of the first neighboring eNB 1010 is 10 MHz, the communication device in the serving cell is assumed to obtain channel bandwidth information of the first neighboring eNB 1010 from the database offline or online. The communication device may measure a signal of the serving eNB 1000 with the bandwidth 5 MHz and measure a signal of the first neighboring eNB 1010 with the bandwidth 10 MHz. The communication device may concurrently measure the signals of the serving eNB 1000 and the first neighboring eNB 1010 using the bandwidth 5 MHz which is smaller than 10 MHz.

In FIG. 10C, when the channel bandwidth (or the first bandwidth) of the serving eNB 1000 is 5 MHz, the measurement bandwidth (or the second bandwidth) is 3 MHz, and the channel bandwidth of the first neighboring eNB 1010 is 3 MHz, the communication device in the serving cell is assumed to obtain channel bandwidth information of the first neighboring eNB 1010 from the database offline or online. The communication device may measure a signal of the serving eNB 1000 with the bandwidth 5 MHz and measure a signal of the first neighboring eNB 1010 with the bandwidth 3 MHz. The communication device may concurrently measure the signals of the serving eNB 1000 and the first neighboring eNB 1010 using the bandwidth 3 MHz which is smaller than 5 MHz.

In FIG. 10D, it is assumed that the channel bandwidth (or the first bandwidth) of the serving eNB 1000 is 5 MHz, the measurement bandwidth (or the second bandwidth) is 3 MHz, and channel bandwidth information of the first neighboring eNB 1010 is unknown. The communication device may measure a signal of the serving eNB 1000 with the channel bandwidth 5 MHz and measure a signal of the first neighboring eNB 1010 with the measurement bandwidth 3 MHz. The communication device may concurrently measure the signals of the serving eNB 1000 and the first neighboring eNB 1010 using the measurement bandwidth 3 MHz which is smaller than the channel bandwidth 5 MHz of the serving eNB 1000.

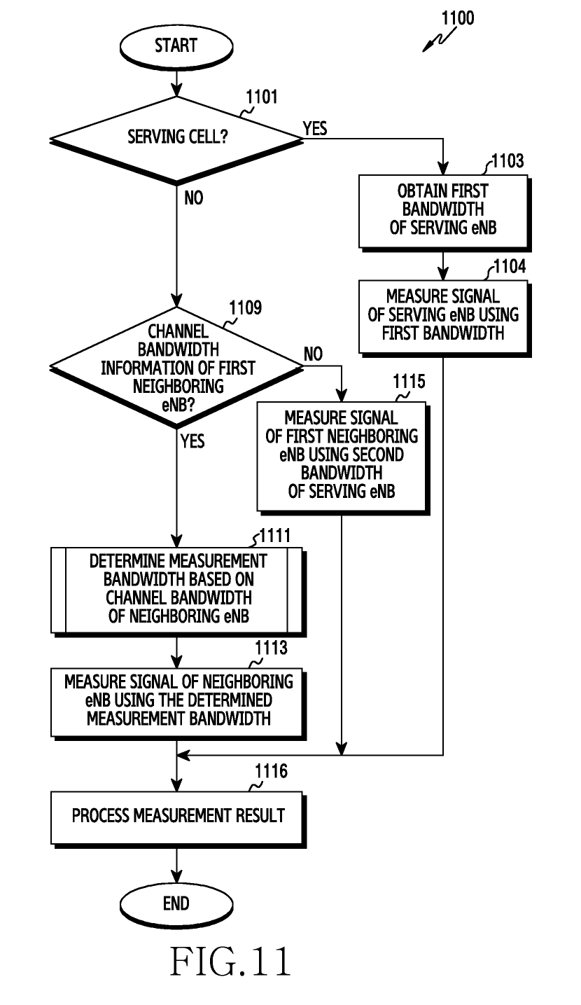

FIG. 11 is a flowchart of a method for intra-frequency measurement in a UE, according to an embodiment of the present disclosure.

Referring to FIG. 11, the communication device determines whether to measure a serving cell (or a serving eNB) in step 1101.

For the inter-frequency measurement of the serving eNB, the communication device obtains a first bandwidth of the serving eNB (i.e., a channel bandwidth of the serving eNB) in step 1103. In step 1104, the communication device measures a signal of the serving eNB using the first bandwidth.

For the intra-frequency measurement of a neighboring eNB, the communication device determines whether there is channel bandwidth information of the first neighboring eNB in step 1109.

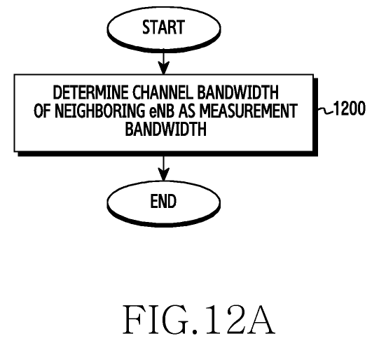

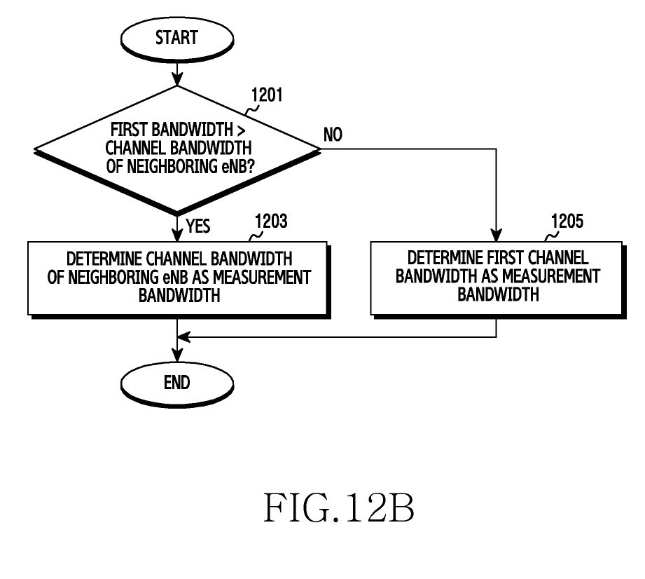

With the channel bandwidth information of the first neighboring eNB, the communication device may determine the measurement bandwidth based on the channel bandwidth of the first neighboring eNB in step 1111 (see FIGS. 12A and 12B). In step 1113, the communication device measures a signal of the first neighboring eNB using the determined measurement bandwidth.

Without the channel bandwidth information of the first neighboring eNB, the communication device measures a signal of the first neighboring eNB using a second bandwidth determined by the serving eNB (i.e., the measurement bandwidth received over the dedicated control channel) in step 1115.

In step 1116, the communication device processes the measurement result using the corresponding frequency band. For example, the communication device may report the measurement result to the serving eNB 110. Based on the measurement result, the communication device may perform the cell selection or handover. The communication device may display the measurement result on the display 440 under control of the processor 410.

FIGS. 12A and 12B are flowcharts of a method for determining a measurement bandwidth based on a channel bandwidth of a neighboring eNB, according to an embodiment of the present disclosure.

Referring to FIG. 12A, the communication device determines a channel bandwidth determined by the first neighboring eNB, as a signal measurement bandwidth in step 1200. In so doing, the signal measurement bandwidth of the serving eNB may be set to a first bandwidth.

Referring to FIG. 12B, in step 1201, the communication device determines whether the first bandwidth determined by the serving eNB is greater than a channel bandwidth determined by the first neighboring eNB.

When the first bandwidth determined by the serving eNB is greater than the channel bandwidth determined by the first neighboring eNB, the communication device determines the channel bandwidth determined by the first neighboring eNB, as a signal measurement bandwidth in step 1203. The channel bandwidth determined by the first neighboring eNB may be used to measure signals of the first neighboring eNB and the serving eNB.

When the first bandwidth determined by the serving eNB is smaller than the channel bandwidth determined by the first neighboring eNB, the communication device may determine the first channel bandwidth as a signal measurement bandwidth in step 1205. The first channel bandwidth may be used to measure signals of the first neighboring eNB and the serving eNB.

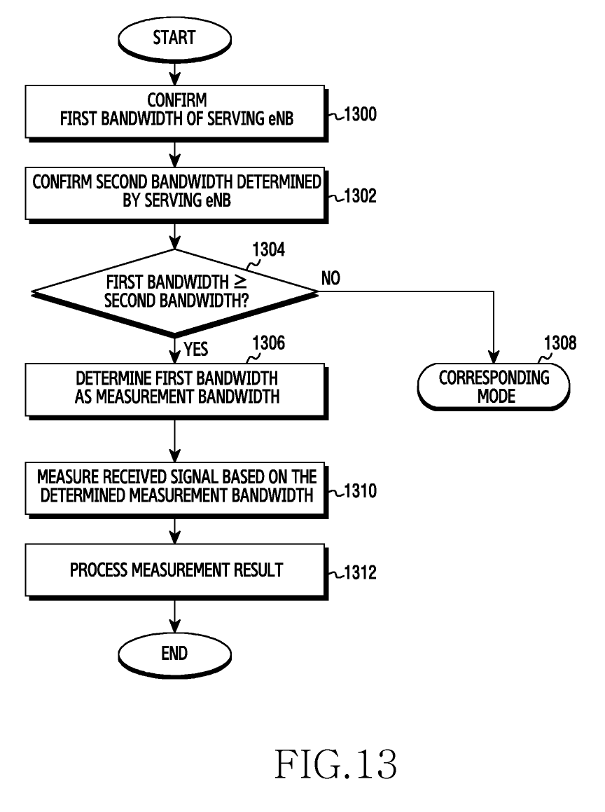

FIG. 13 is a flowchart of a method for intra-frequency measurement in a UE, according to an embodiment of the present disclosure.

Referring to FIG. 13, the communication device confirms a first bandwidth of the eNB in step 1300. For example, the communication device 420 receives channel bandwidth information of a serving eNB from the serving eNB 110 over a broadcast channel, or determines whether the memory 430 stores channel bandwidth information of a serving eNB previously received. In step 1302, the communication device may confirm a second bandwidth determined by the eNB. For example, the communication device 420 receives measurement bandwidth information from the serving eNB 110 over a dedicated control channel, or determines whether the memory 430 stores a measurement bandwidth previously measured.

In step 1304, the communication device compares the first bandwidth and the second bandwidth. When the first bandwidth is greater than or equal to the second bandwidth, the communication device method goes to step 1306. When the first bandwidth is smaller than the second bandwidth, the communication device method goes to step 1308.

In step 1306, the communication device determines the first bandwidth as a received signal measurement bandwidth. For example, the communication device may measure a signal of the serving eNB based on the channel bandwidth of the serving eNB. In step 1308, the communication device enters a corresponding mode. For example, the communication device in the corresponding mode may determine one of the first bandwidth and the second bandwidth as the received signal measurement bandwidth.

In step 1310, the communication device measures a received signal based on the first bandwidth. For example, the communication device may adjust a parameter (e.g., a filter bandwidth, an FFT size) of an element of the receiver according to the first bandwidth and then measure the received signal. The received signal measurement value may include one or more of the RSRP, the RSSI, and the RSRQ.

In step 1312, the communication device processes the measurement result. For example, the communication device may report the measurement result to the serving eNB 110 through the transmitter. Based on the measurement result, the communication may perform the cell selection or the handover. According to an embodiment of the present disclosure, the communication device may display the measurement result on the display 440 under control of the processor 410.

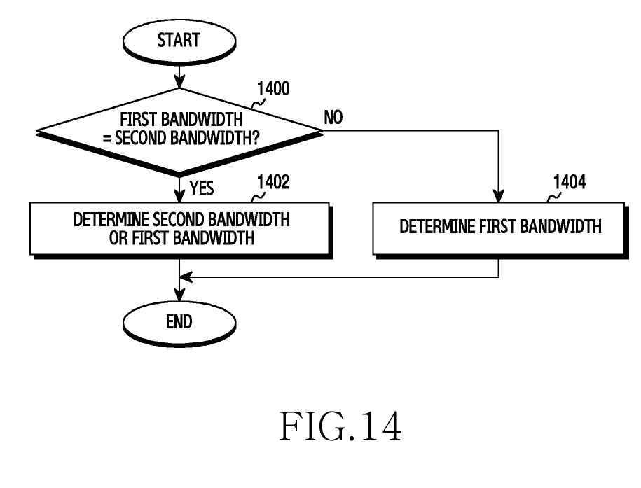

FIG. 14 is a flow chart of a method for determining a bandwidth in a UE, according to an embodiment of the present disclosure.

Referring to FIG. 14, the communication device compares the first bandwidth and the second bandwidth in step 1400. The first bandwidth is the channel bandwidth of the serving eNB received over the broadcast channel, and the second bandwidth is the measurement bandwidth of the communication device received over the dedicated control channel.

When the first bandwidth is the same as the second bandwidth, the communication device method goes to step 1402. When the first bandwidth is different from the second bandwidth, the communication device method goes to step 1404.

In step 1402, the communication device determines the second bandwidth (or the first bandwidth) as the received signal measurement bandwidth. In step 1404, the communication device determines the first bandwidth as the received signal measurement bandwidth.

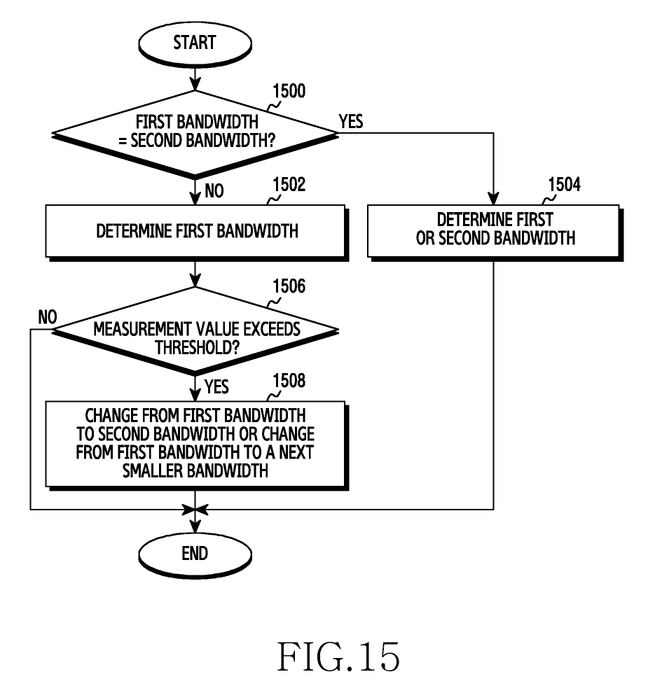

FIG. 15 is a flowchart of another method for determining a bandwidth in a UE, according to an embodiment of the present disclosure.

Referring to FIG. 15, the communication device compares the first bandwidth and the second bandwidth in step 1500. The first bandwidth is the channel bandwidth of the serving eNB received over the broadcast channel, and the second bandwidth is the measurement bandwidth of the communication device received over the dedicated control channel.

When the first bandwidth is the same as the second bandwidth, the communication device method goes to step 1504. When the first bandwidth is different from the second bandwidth, the communication device method goes to step 1502.

In step 1504, the communication device determines the second bandwidth (or the first bandwidth) as the received signal measurement bandwidth. In step 1502, the communication device determines the first bandwidth as the received signal measurement bandwidth.

In step 1506, the communication device determines whether the measurement value (e.g., the RSRP) exceeds a threshold. When the measurement value does not exceed the threshold, the communication device completes the process. When the measurement value exceeds the threshold, the communication device method goes to step 1508.

In step 1508, the communication device may change the received signal measurement bandwidth from the first bandwidth to the second bandwidth. The communication device may change the received signal measurement bandwidth from the first bandwidth to a next smaller bandwidth.

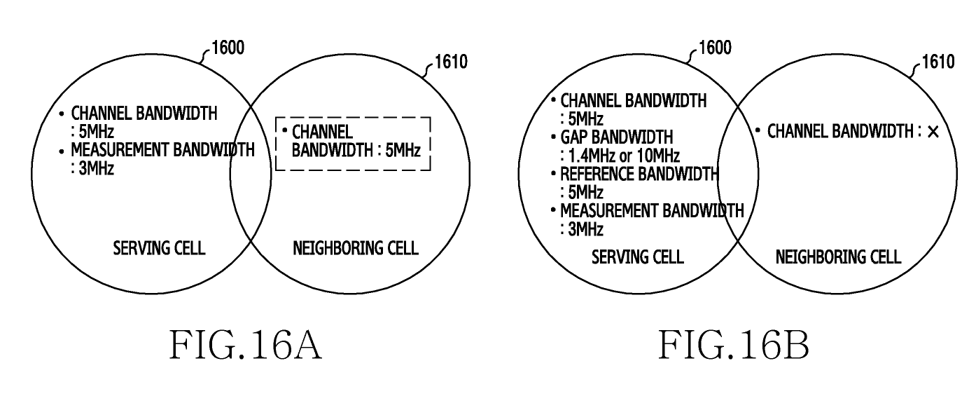

FIGS. 16A and 16B illustrate inter-frequency measurement and inter-RAT measurement, according to an embodiment of the present disclosure.

In FIG. 16A, when a channel bandwidth (or a first bandwidth) of a serving eNB 1600 is 5 MHz, a measurement bandwidth (or a second bandwidth) is 3 MHz, and a channel bandwidth of a second neighboring eNB 1610 is 5 MHz, the communication device in the serving cell is assumed to obtain channel bandwidth information of the second neighboring eNB from the database offline or online. The second neighboring eNB 1610 is an eNB using a different center frequency or a different RAT from the serving eNB 1600. The communication device may measure a signal of the second eNB using the bandwidth 5 MHz.

In FIG. 16B, it is assumed that the channel bandwidth (or the first bandwidth) of the serving eNB 1600 is 5 MHz, the measurement bandwidth (or the second bandwidth) is 3 MHz, and channel bandwidth information of the second neighboring eNB 1610 is unknown to the communication device.

When the gap bandwidth is greater than or equal to the reference bandwidth, the communication device may measure a signal of the second neighboring eNB using the gap bandwidth. When the gap bandwidth is smaller than the reference bandwidth and when the measurement bandwidth received over the dedicated control channel is greater than, or equal to, the reference bandwidth, the communication device may measure a signal of the second neighboring eNB using the measurement bandwidth. When the measurement bandwidth is smaller than the reference bandwidth, the communication device may estimate the channel bandwidth of the second neighboring eNB and then measure a signal of the second neighboring eNB using the estimated channel bandwidth of the second neighboring eNB.

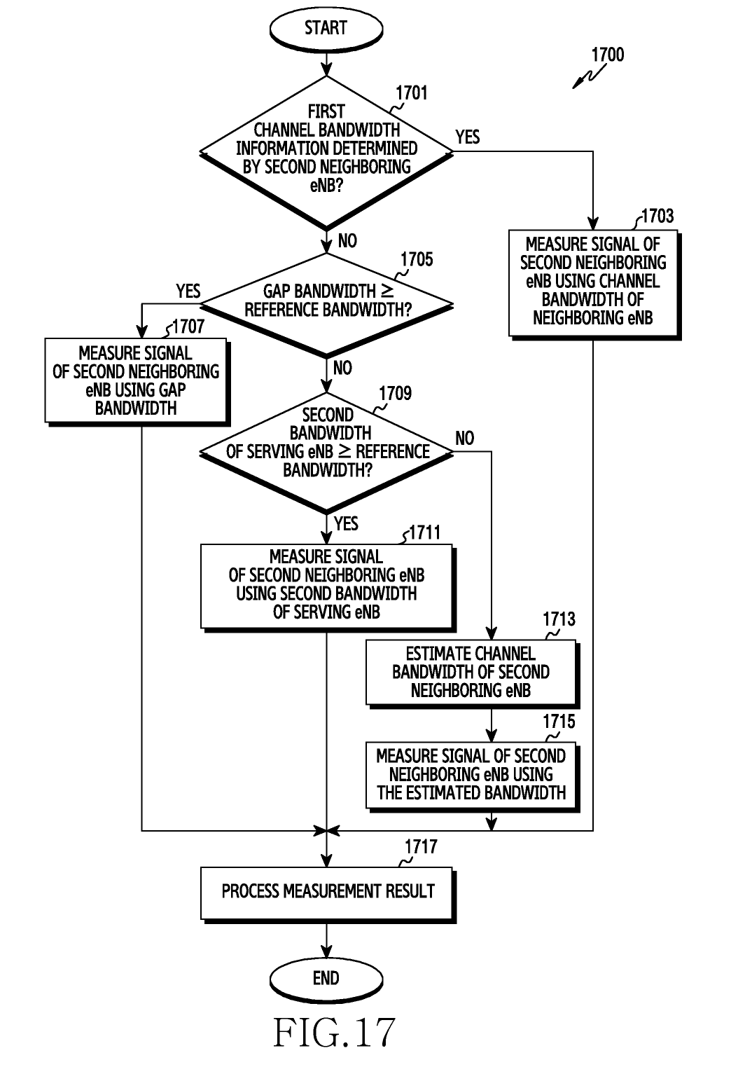

FIG. 17 is a flowchart of a method of inter-frequency measurement and inter-RAT measurement in a UE, according to an embodiment of the present disclosure.

Referring to FIG. 17, the communication device determines whether there is channel bandwidth information of the second neighboring eNB in step 1701.

With the channel bandwidth information of the second neighboring eNB, the communication device measures a signal of the second neighboring eNB using the channel bandwidth of the second neighboring eNB in step 1703.

Without the channel bandwidth information of the second neighboring eNB, the communication device compares the gap bandwidth and the reference bandwidth in step 1705. The gap bandwidth is the bandwidth agreed to be used between the eNB and the UE in the transmission gap 730 of FIG. 7A. Advantageously, the gap bandwidth may include either 1.4 MHz or 10 MHz. The reference bandwidth is the predicted bandwidth satisfying the measurement quality. For example, when the UE uses the reference bandwidth, the reference bandwidth guarantees the measurement quality and thus may be set to a default value.

When the gap bandwidth is greater than or equal to the reference bandwidth, the communication device measures a signal of the second neighboring eNB using the gap bandwidth in step 1707.

When the gap bandwidth is smaller than the reference bandwidth, the communication device compares the measurement bandwidth (or the second bandwidth) received over the dedicated control channel with the reference bandwidth in step 1709.

When the measurement bandwidth received over the dedicated control channel is greater than or equal to the reference bandwidth, the communication device measures a signal of the second neighboring eNB using the second bandwidth (i.e., the measurement bandwidth) of the serving eNB in step 1711.

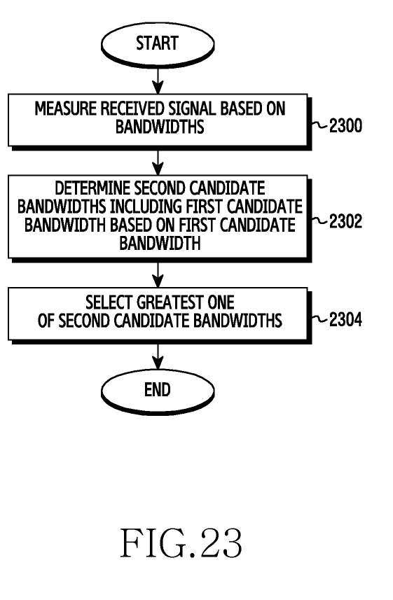

When the measurement bandwidth is smaller than the reference bandwidth, the communication device estimates the channel bandwidth of the second neighboring eNB as shown in FIG. 23, in step 1713.

In step 1715, the communication device measures a signal of the second neighboring eNB using the estimated channel bandwidth of the second neighboring eNB.

In step 1717, the communication device processes the measurement result. For example, the communication device may report the measurement result to the serving eNB 110 through the transmitter. Based on the measurement result, the communication may perform cell selection or handover. According to another embodiment of the present disclosure, the communication device may display the measurement result on the display 440 under control of the processor 410.

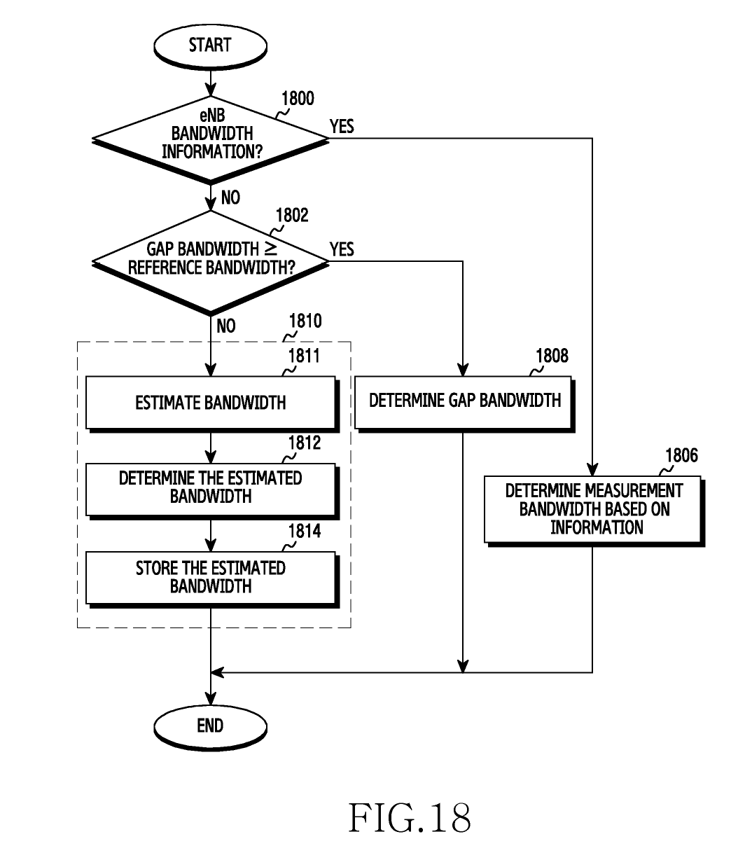

FIG. 18 is a flowchart of a method for determining a bandwidth in a UE, according to another embodiment of the present disclosure.

Referring to FIG. 18, the communication device determines whether there is channel bandwidth information of the second neighboring eNB to measure in step 1800. For example, the communication device may determine whether the memory 430 stores the channel bandwidth of the second neighboring eNB received from the database or the channel bandwidth of the second neighboring eNB previously estimated.

With the channel bandwidth information of the second neighboring eNB to measure, the communication device determines the measurement bandwidth based on the information in step 1806. For example, the communication device may determine the channel bandwidth of the second neighboring eNB stored in the memory 430, as the measurement bandwidth.

In step 1802, the communication device compares the gap bandwidth and the reference bandwidth. When the gap bandwidth is equal to, or greater than, the reference bandwidth, the communication device method goes to step 1808. When the gap bandwidth is smaller than the reference bandwidth, the communication device method goes to step 1810.

In step 1808, the communication device determines the gap bandwidth as the measurement bandwidth.

In step 1810, the communication device performs steps 1811, 1812, and 1814. For example, in step 1811, the communication device estimates the channel bandwidth of the second neighboring eNB to measure as shown in FIG. 23. In step 1812, the communication device determines the estimated channel bandwidth of the second neighboring eNB, as the measurement bandwidth. In step 1814, the communication device stores the estimated channel bandwidth of the second neighboring eNB, in the memory 430 or the database. The database may provide the channel bandwidth information of the second neighboring eNB to other UEs.

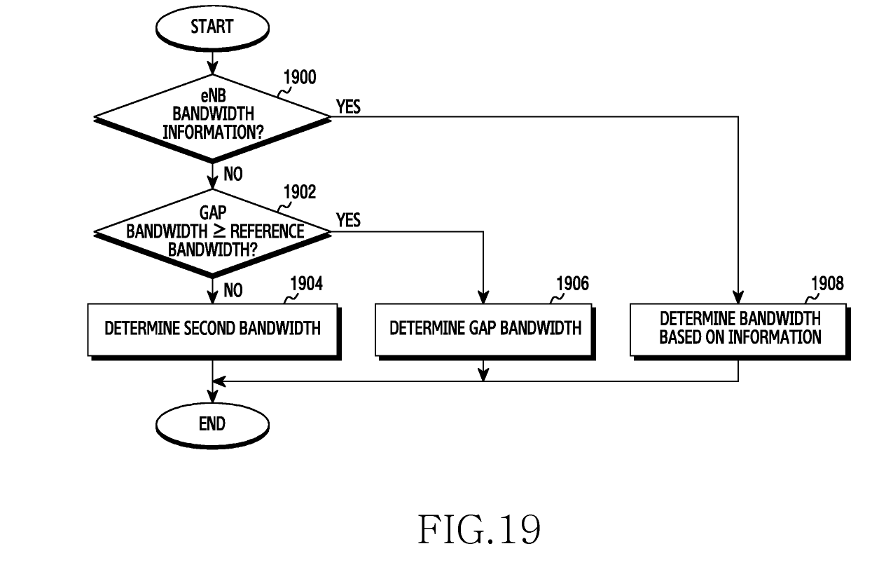

FIG. 19 is a flowchart of a method for determining a bandwidth in a UE, according to another embodiment of the present disclosure.

Referring to FIG. 19, the communication device determines whether there is channel bandwidth information of the second neighboring eNB to measure in step 1900. For example, the communication device may determine whether the memory 430 stores the channel bandwidth of the second neighboring eNB received from the database or the channel bandwidth of the second neighboring eNB previously estimated.

With the channel bandwidth information of the second neighboring eNB to measure, the communication device determines the measurement bandwidth based on the information in step 1908. For example, the communication device may determine the channel bandwidth of the second neighboring eNB stored in the memory 430, as the measurement bandwidth.

In step 1902, the communication may compare the gap bandwidth and the reference bandwidth. When the gap bandwidth is equal to, or greater than, the reference bandwidth, the communication device method goes to step 1906. When the gap bandwidth is smaller than the reference bandwidth, the communication device method goes to step 1904. In step 1904, the communication device determines the second bandwidth (i.e., the UE measurement bandwidth received over the dedicated control channel) as the signal measurement bandwidth. In step 1906, the communication device determines the gap bandwidth as the measurement bandwidth.

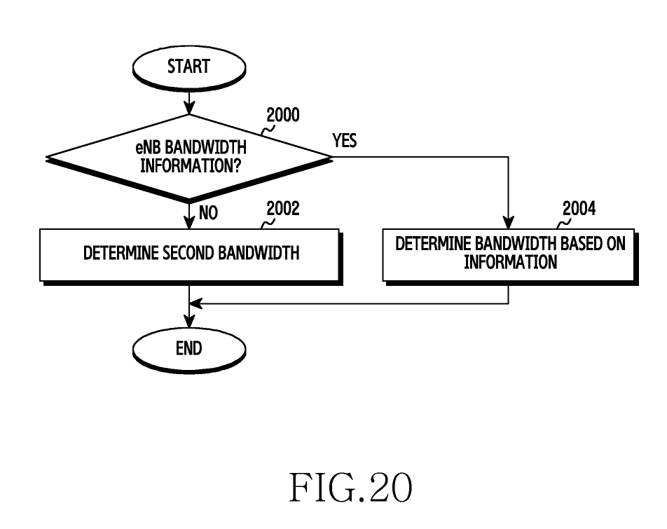

FIG. 20 is a flowchart of a method of determining a bandwidth in a UE, according to another embodiment of the present disclosure.

Referring to FIG. 20, the communication device determines whether there is channel bandwidth information of the second neighboring eNB to measure in step 2000. For example, the communication device may determine whether the memory 430 stores the channel bandwidth of the second neighboring eNB received from the online or offline database or the channel bandwidth of the second neighboring eNB previously estimated.

With the channel bandwidth information of the second neighboring eNB to measure, the communication device determines the measurement bandwidth based on the information in step 2004. For example, the communication device may determine the channel bandwidth of the second neighboring eNB stored in the memory 430, as the measurement bandwidth.

Without the channel bandwidth information of the second neighboring eNB to measure, the communication device determines the second bandwidth as the measurement bandwidth in step 2002.

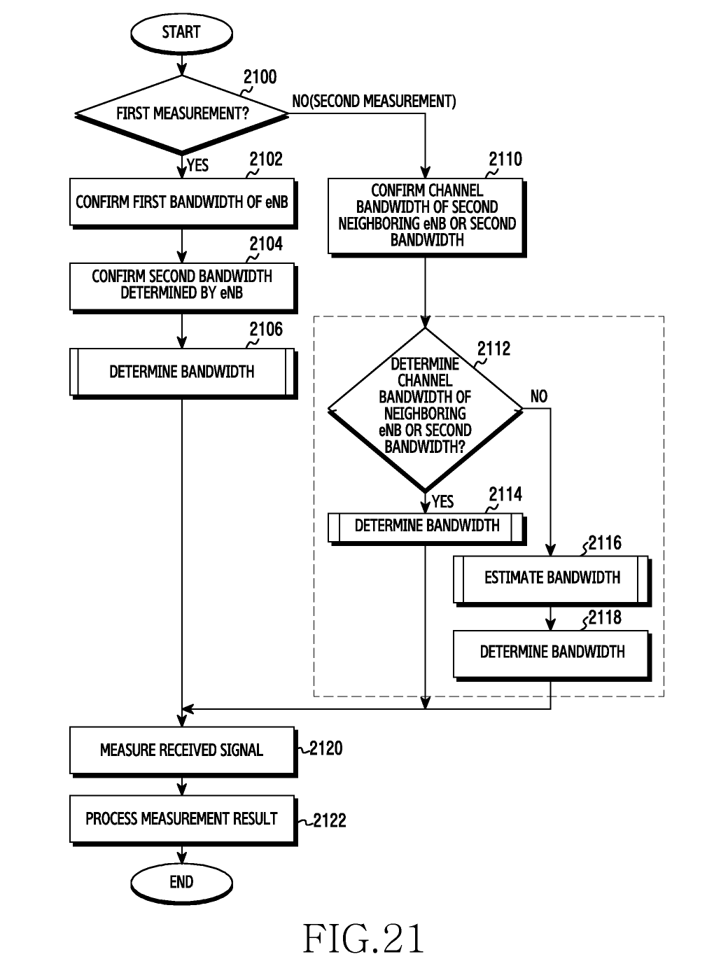

FIG. 21 is a flowchart of a method for determining a bandwidth in a UE, according to another embodiment of the present disclosure.

Referring to FIG. 21, the communication device determines a first measurement or a second measurement in step 2100. The first measurement may be the intra-frequency measurement, and the second measurement may be either the inter-frequency measurement or the inter-RAT measurement. For example, the communication device in connected mode may determine the first measurement or the second measurement according to the transmission interval 740 and the transmission gap 730 of FIG. 7A. That is, the communication device may perform the intra-frequency measurement in the transmission interval 740 and perform the inter-frequency measurement and the inter-RAT measurement in the transmission gap 730.

The communication device in idle mode may conduct the first measurement and the second measurement in the measurement interval 720 of the wakeup interval of FIG. 7B. In so doing, the first measurement and the second measurement may be completed based on time sharing. For example, the first measurement may be conducted at a first time point and the second measurement may be conducted at a second time point.

For the first measurement, the communication device confirms a first bandwidth of the eNB in step 2102. For example, the communication device 420 determines whether the channel bandwidth of the serving eNB 110 is received from the serving eNB 110 or the memory 430 stores the eNB channel bandwidth previously received. The channel bandwidth may include one of 1.4 MHz, 3 MHz, 5 MHz, 10 MHz, 15 MHz, and 20 MHz, however the present disclosure is not limited to those bandwidths. In step 2104, the communication device confirms a second bandwidth of the eNB. The second bandwidth may be the measurement bandwidth received from the serving eNB over the dedicated control channel. The measurement bandwidth may include one of 1.4 MHz, 3 MHz, 5 MHz, 10 MHz, 15 MHz, and 20 MHz. The measurement bandwidth may be narrower than the channel bandwidth.

In step 2106, the communication device determines the bandwidth for the intra-frequency measurement as in steps 1304 and 1306 of FIG. 13 or as shown in FIG. 14 by comparing the first bandwidth and the second bandwidth. For example, when the first bandwidth is greater than, or equal to, the second bandwidth, the communication device may determine the first bandwidth as the received signal measurement bandwidth. Alternatively, when the first bandwidth is different from the second bandwidth, the communication device may determine the first bandwidth as the received signal measurement bandwidth.

For the second measurement, the communication device confirms a channel bandwidth of a second neighboring eNB or a second bandwidth in step 2110.

In step 2112, the communication device may determine whether the channel bandwidth of the second neighboring eNB or the second bandwidth may be determined as the received signal measurement bandwidth. For example, the communication device determines whether the channel bandwidth information of the second neighboring eNB to measure is received from the database or the channel bandwidth of the second neighboring eNB is estimated previously.

Using the channel bandwidth of the second neighboring eNB to measure from the database or the second bandwidth from the database, the communication device method goes to step 2114. Otherwise, the communication device method goes to step 2116.

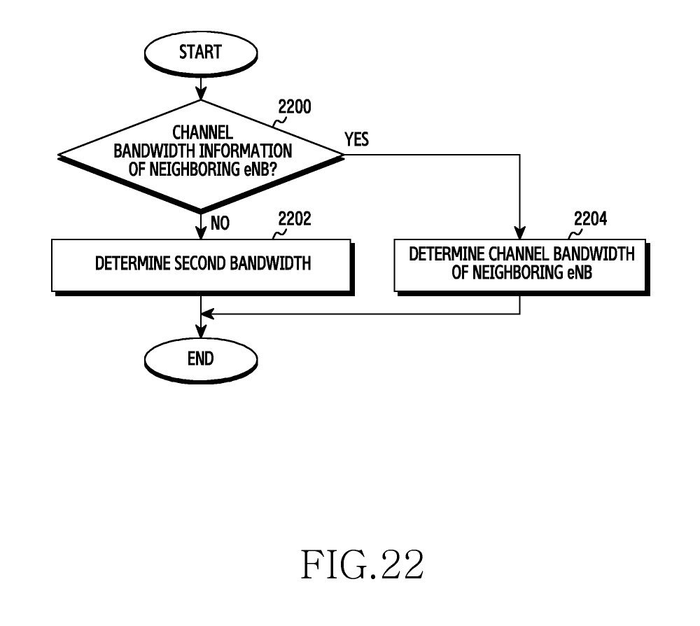

In step 2114, the communication device determines the bandwidth for the second measurement using the channel bandwidth of the second neighboring eNB and the second bandwidth as shown in FIG. 22.

In step 2116, the communication device estimates the channel bandwidth of the second neighboring eNB to measure (see FIG. 23).

In step 2118, the communication device determines the estimated bandwidth as the received signal measurement bandwidth.

In step 2120, the communication device measures a received signal based on the determined channel bandwidth. For example, the communication device may adjust a parameter (e.g., the filter bandwidth, the FFT size) of an element of the receiver according to the determined channel bandwidth, and then measure the received signal. The received signal measurement value may include one or more of the RSRP, the RSSI, and the RSRQ.

In step 2122, the communication device processes the measurement result. For example, the communication device may report the measurement result to the serving eNB 110 through the transmitter. Based on the measurement result, the communication may perform cell selection or handover. According to another embodiment of the present disclosure, the communication device may display the measurement result on the display 440 under control of the processor 410.

FIG. 22 is a flowchart of a method for determining a bandwidth in a UE, according to another embodiment of the present disclosure.

Referring to FIG. 22, the communication device may determine whether there is channel bandwidth information of the second neighboring eNB previously estimated in step 2200.

Without the channel bandwidth information of the second neighboring eNB to measure or the previously estimated channel bandwidth information of the second neighboring eNB, the communication device determines the second bandwidth as the signal measurement bandwidth in step 2202.

With the channel bandwidth information of the second neighboring eNB to measure or the previously estimated channel bandwidth information of the second neighboring eNB, the communication device determines the channel bandwidth of the second neighboring eNB as the signal measurement bandwidth in step 2204.

FIG. 23 is a flowchart of a method for estimating a channel bandwidth of an eNB in a UE according to an embodiment of the present disclosure.

Referring to FIG. 23, the communication device measures a received signal of a neighboring eNB using a plurality of bandwidths (e.g., 1.4 MHz, 3 MHz, 5 MHz, 10 MHz, 15 MHz, and 20 MHz) in step 2300. The bandwidths may include all the available bandwidths in the system. Alternatively, the bandwidths may include bandwidths greater than the measurement bandwidth determined by the eNB or the gap bandwidth. A first candidate bandwidth may include the measurement bandwidth or the gap bandwidth.

In step 2302, the communication device determines the first candidate bandwidth and second candidate bandwidths. For example, the second candidate bandwidths may include bandwidths satisfying Equation (1) below, where a difference of received signal measurement values corresponding to the bandwidths and the first candidate bandwidth exceeds a threshold.

|RSRP_{{RBX}}−RSRP_{X}|≦δ (1)

X denotes the first candidate bandwidth (e.g., the measurement bandwidth determined by the eNB or the gap bandwidth), {RBX} denotes a bandwidth set greater than X, RSRP_{X} denotes an RSRP value measured based on the measurement bandwidth, RSRP_{{RBX}} denotes a plurality of RSRP values measured based on a plurality of bandwidths greater than X, and δ denotes a threshold.

In step 2304, the communication device selects the greatest one of the second candidate bandwidths. That is, the communication device may determine the selected bandwidth as the channel bandwidth of the neighboring eNB to measure.

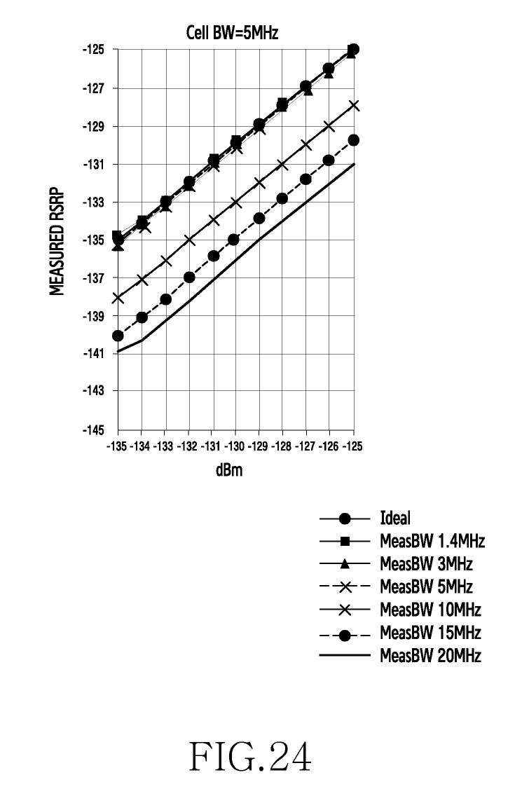

For example, when the channel bandwidth of the neighboring eNB to measure is 5 MHz (e.g., 25 RB), the communication device determines 1.4 MHz, 3 MHz, 5 MHz, 10 MHz, 15 MHz, and 20 MHz (RB=6, 15, 25, 50, and 100) as the measurement bandwidth and measures a received signal of the neighboring eNB to measure based on the determined bandwidth. The measurement result is shown in the graph of FIG. 24, where the measurement results are represented as RSRP6, RSRP15, RSRP25, RSRP50, RSRP75, and RSRP100. For example, when the gap bandwidth is 1.4 MHz, the communication device calculates a difference between the measurement value RSRP6 corresponding to the first candidate bandwidth and the measurement values RSRP15, RSRP25, RSRP50, RSRP75, and RSRP100.

Next, the communication device determines second candidate bandwidths (e.g., RSRP6, RSRP15, and RSRP25 when δ=1 dB) satisfying |RSRP_{{RBX}}−RSRP₆|≦δ.

Finally, the communication device may determine the greatest bandwidth of 1.4 MHz, 3 MHz, and 5 MHz corresponding to RSRP6, RSRP15, and RSRP15, as the channel bandwidth of the neighboring eNB to measure.

FIG. 24 is a graph of eNB channel bandwidth measurements in a UE, according to an embodiment of the present disclosure.

FIG. 24 shows RSRP values of a neighboring eNB measured with measurement bandwidths 1.4 MHz, 3 MHz, 5 MHz, 10 MHz, 15 MHz, and 20 MHz (RB=6, 15, 25, 50, and 100) when a channel bandwidth of the neighboring eNB to measure is 5 MHz (e.g., 25 RB).

When the channel bandwidth of the measuring eNB is greater than the measurement bandwidth of the eNB in the intra-frequency measurement of the UE, the measurement with the channel bandwidth of the measuring eNB may enhance accuracy and reliability of the measurement. For example, when the channel bandwidth of the measuring eNB is 20 MHz (100 RB) and the measurement bandwidth determined by the eNB is 6 RB (1.4 MHz), the measurement may utilize 100 RB instead of 6 RB.

When the UE obtains channel bandwidths of the EARFCN (or the first and second neighboring eNBs) corresponding to the UE location from the offline or online database in the case of the inter-frequency measurement or the inter-RAT measurement and the channel bandwidth of the neighboring eNB is greater than the measurement bandwidth determined by the serving eNB, the inter-frequency measurement or the inter-RAT measurement may be provided with the channel bandwidth of the neighboring eNB.

Without knowing the channel bandwidths of the EARFCN (or the first and second neighboring eNBs) corresponding to the UE location from the offline or online database in the inter-frequency measurement or the inter-RAT measurement, when the gap bandwidth determined by the serving eNB exceeds the reference bandwidth (e.g., 10 MHz), accuracy and reliability of the measurement result may be ensured and accordingly, the inter-frequency measurement or the inter-RAT measurement may carried out using the gap bandwidth.

Without knowing the channel bandwidths of the EARFCN (or the first and second neighboring eNBs) corresponding to the UE location in the inter-frequency measurement or the inter-RAT measurement, when the gap bandwidth determined by the eNB falls below the reference bandwidth (e.g., 14 MHz), the UE may estimate the channel bandwidth of the corresponding neighboring eNB and conduct the inter-frequency measurement or the inter-RAT measurement using the estimated bandwidth.

The above-described methods according to various embodiments of the present disclosure may be implemented in software, firmware, hardware, or in their combinations.

As for the software, a non-transitory computer-readable storage medium storing one or more programs (software modules) may be provided. One or more programs stored in the non-transitory computer-readable storage medium may be configured for execution by one or more processors of the electronic device. One or more programs may include instructions for controlling the electronic device to execute the methods according to the embodiments of the present disclosure.

A program (software module, software) may be stored in a random access memory, a non-volatile memory including a flash memory, a read only memory (ROM), an electrically erasable programmable ROM (EEPROM), a magnetic disc storage device, a compact disc (CD)-ROM, digital versatile discs (DVDs) or other optical storage devices, and a magnetic cassette. Alternatively, the programs may be stored in a memory combining part or all of those recording media. A plurality of memories may be used.

The programs may be stored in an attachable storage device accessible via a communication network such as the Internet, Intranet, local area network (LAN), WLAN, or storage area network (SAN), or a communication network by combining these networks. The storage device may access the electronic device through an external port.

A separate storage device may access the electronic device over the communication network.

As set forth above, by measuring the signal in the bandwidth greater than the measurement bandwidth determined by the eNB, the communication device may gain the received signal measurement value of high accuracy and reliability.

While the present disclosure has been shown and described with reference to certain embodiments, it will be understood by those skilled in the art that various changes in form and details may be made therein without departing from the spirit and scope of the present disclosure as defined by the appended claims and their equivalents.

What is claimed is:

1. An apparatus of a user equipment (UE) for measuring a quality of a received signal, the apparatus comprising:
a bandwidth setting unit configured to: determine a measurement bandwidth for a neighboring BS based on at least one bandwidth determined by a serving BS of the UE; and
a measurement unit configured to measure a quality of the received signal based on the measurement bandwidth for the neighboring BS.

2. The apparatus of claim 1, wherein, in order to determine the measurement bandwidth, the bandwidth setting unit is configured to:
determine a measurement type among a plurality of measurement types, and
determine the measurement bandwidth determined based on the at least one bandwidth, and the determined measurement type,
wherein the plurality of measurement types comprises a intra-frequency measurement, a inter-frequency measurement, and inter-radio access technology (RAT) measurement.

3. The apparatus of claim 2, wherein if the measurement type is intra-frequency measurement, and information for a channel bandwidth for the neighboring BS is in a storage of the UE, the bandwidth setting unit is configured to determine the measurement bandwidth by using a smaller bandwidth between a channel bandwidth for the serving BS and the channel bandwidth for the neighboring BS,
wherein the at least one bandwidth determined by the serving BS comprises the channel bandwidth for the serving BS.

4. The apparatus of claim 2, wherein, if the measurement type is the intra-frequency measurement, the bandwidth setting unit is configured to determine the measurement bandwidth by using a measurement bandwidth for the serving BS,
wherein the at least one bandwidth determined by the serving BS comprises the measurement bandwidth for the serving BS.

5. The apparatus of claim 2, wherein, if the measurement type is the inter-frequency measurement or inter-radio access technology (RAT) measurement, the bandwidth setting unit is configured to determine the measurement bandwidth by using the at least one bandwidth determined by the serving BS,
wherein the at least one bandwidth comprises:
a gap bandwidth indicating a frequency bandwidth used in a gap for the inter-frequency measurement or the inter-RAT measurement; and
a measurement bandwidth for the serving BS.

6. The apparatus of claim 5, wherein, if the gap bandwidth is greater than, or equal to, a reference bandwidth, the bandwidth setting unit is configured to determine the measurement bandwidth by using the gap bandwidth.

7. The apparatus of claim 5, wherein, if the gap bandwidth is less than the reference bandwidth, the bandwidth setting unit is configured to:
if the measurement bandwidth for the serving BS is greater than or equal to a reference bandwidth, determine the measurement bandwidth by using the measurement bandwidth for the serving BS.

8. The apparatus of claim 7, wherein, if the measurement bandwidth for the serving BS is less than the reference bandwidth, the bandwidth setting unit is configured to:
determine a first candidate bandwidth among the plurality of bandwidths;
determine at least one second candidate bandwidth based on the first candidate bandwidth;
select a greatest bandwidth among the at least one second candidate bandwidth; and
determine the measurement bandwidth for the neighboring BS by using the greatest bandwidth.

9. The apparatus of claim 2, wherein if the measurement type is the inter-frequency measurement or inter-radio access technology (RAT) measurement, and information for a channel bandwidth for the neighboring BS is in a storage of the UE, the bandwidth setting unit is configured to determine the measurement bandwidth by using the channel bandwidth for the neighboring BS,
wherein the at least one bandwidth determined by the serving BS comprises the channel bandwidth for the serving BS.

10. The apparatus of claim 1, wherein the quality of the received signal indicates at least one of reference symbol received power (RSRP), received signal strength indicator (RSSI), and reference symbol received quality (RSRQ).

11. A method for operating a user equipment (UE) for measuring a quality of a received signal, the method comprising:
determining a measurement bandwidth for a neighboring base station (BS) based on at least one bandwidth determined by a serving BS of the UE; and
measuring a quality of the received signal based on the measurement bandwidth for the neighboring BS.

12. The method of claim 11, wherein determining the measurement bandwidth comprises:
determining a measurement type among a plurality of measurement types, and
determining the measurement bandwidth determined based on the at least one bandwidth, and the determined measurement type,
wherein the plurality of measurement types comprises a intra-frequency measurement, a inter-frequency measurement, and inter-radio access technology (RAT) measurement.

13. The method of claim 12, wherein determining the measurement bandwidth comprises:
if the measurement type is the intra-frequency measurement, and information for a channel bandwidth for the neighboring BS is in a storage of the UE, determining the measurement bandwidth by using a smaller channel bandwidth between a channel bandwidth for the serving BS and the channel bandwidth for the neighboring BS,
wherein the at least one bandwidth determined by the serving BS comprises the channel bandwidth for the serving BS.

14. The method of claim 12, wherein determining the measurement bandwidth comprises:
if the measurement type is the intra-frequency measurement, determining the measurement bandwidth by using a measurement bandwidth for the serving BS,
wherein the at least one bandwidth determined by the serving BS comprises the measurement bandwidth for the serving BS.

15. The method of claim 12, wherein determining the measurement bandwidth comprises:
if the measurement type is inter-frequency measurement or inter-radio access technology (RAT) measurement, determining the measurement bandwidth by using at least one bandwidth determined by the serving BS,
wherein the at least one bandwidth comprises:
a gap bandwidth indicating a frequency bandwidth used in a gap for the inter-frequency measurement or the inter-RAT measurement; and
a measurement bandwidth for the serving BS.

16. The method of claim 15, wherein determining the measurement bandwidth comprises:
if the gap bandwidth is greater than or equal to a reference bandwidth, determining the measurement bandwidth by using the gap bandwidth.

17. The method of claim 15, wherein determining the measurement bandwidth comprises:
if the gap bandwidth is less than the reference bandwidth, and the measurement bandwidth for the serving BS is greater than or equal to a reference bandwidth, determining the measurement bandwidth by using the measurement bandwidth for the serving BS.

18. The method of claim 17, wherein determining the measurement bandwidth comprises:
if the gap bandwidth is less than the reference bandwidth, and the measurement bandwidth for the serving BS is less than the reference bandwidth,
determining a first candidate bandwidth among the plurality of bandwidths;
determining at least one second candidate bandwidth based on the first candidate bandwidth;
selecting a greatest bandwidth among the at least one second candidate bandwidth;
determining the measurement bandwidth for the neighboring BS by using the greatest bandwidth.

19. The method of claim 11, wherein the quality of the received signal indicates at least one of reference symbol received power (RSRP), received signal strength indicator (RSSI), and reference symbol received quality (RSRQ).

20. A communication device for determining a quality of a signal, the communication device comprising:
at least one transceiver configured to receive the signal;
at least one processor configured to:
determine a measurement bandwidth for a base station (BS) based on at least one of a gap bandwidth, a channel bandwidth for a serving BS of the communication device, and a predetermined bandwidth in a storage of the communication device; and
determine the quality of the signal based on the measurement bandwidth for the BS.
